(19) United States
(12) Patent Application Publication
(10) Pub. No.: US 2010/0224783 A1
(43) Pub. Date: Sep. 9, 2010

(54) HIGH PERFORMANCE NEUTRON DETECTOR WITH NEAR ZERO GAMMA CROSS TALK

(75) Inventor: DAVID L. FRANK, Highland Beach, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Innovative American Technology Inc., Coconut Creek, FL (US)

(21) Appl. No.: 12/712,991

(22) Filed: Feb. 25, 2010

Related U.S. Application Data
(63) Continuation-in-part of application No. 12/483,066, filed on Jun. 11, 2009.
Application No. 12/483,066 is a continuation-in-part of application No. 11/624,089, filed on Jan. 17, 2007, now Pat. No. 7,269,527.
Application No. 11/624,089 is a continuation-in-part of application No. 11/852,835, filed on Sep. 10, 2007, now Pat. No. 7,668,681.
Application No. 11/852,835 is a continuation-in-part of application No. 11/564,193, filed on Nov. 28, 2006.
Application No. 11/564,193 is a continuation-in-part of application No. 11/291,574, filed on Dec. 1, 2005, now Pat. No. 7,592,601.
(60) Provisional application No. 61/208,492, filed on Feb. 25, 2009.
(60) Provisional application No. 61/209,194, filed on Mar. 4, 2009.
(60) Provisional application No. 61/210,075, filed on Mar. 13, 2009.
(60) Provisional application No. 61/210,122, filed on Mar. 13, 2009.
(60) Provisional application No. 61/210,234, filed on Mar. 16, 2009.
(60) Provisional application No. 61/210,238, filed on Mar. 16, 2009.
(60) Provisional application No. 61/211,629, filed on Apr. 1, 2009.
(60) Provisional application No. 61/219,111, filed on Jun. 22, 2009.
(60) Provisional application No. 61/231,805, filed on Aug. 6, 2009.
(60) Provisional application No. 61/238,819, filed on Sep. 1, 2009.
(60) Provisional application No. 61/246,299, filed on Sep. 28, 2009.
(60) Provisional application No. 61/249,408, filed on Oct. 7, 2009.
(60) Provisional application No. 61/257,964, filed on Nov. 4, 2009.
(60) Provisional application No. 61/257,968, filed on Nov. 4, 2009.
(60) Provisional application No. 61/289,163, filed on Dec. 22, 2009.
(60) Provisional application No. 61/293,974, filed on Jan. 11, 2010.
(60) Provisional application No. 61/293,993, filed on Jan. 11, 2010.
(60) Provisional application No. 61/131,639, filed on Jun. 11, 2008.

(51) Int. Cl. G01T 1/208; G01T 1/20

(52) U.S. Cl. 250/366; 250/368; 250/369

(57) ABSTRACT

A scintillator system is provided to detect the presence of fissile material and radioactive material. One or more neutron detectors are based on 6LiF mixed in a binder medium with scintillator material, and are optically coupled to one or more wavelength shifting fiber optic light guide media that have a tapered portion extending from the scintillator material to guide light from the scintillator material to a photosensor at the tapered portion. An electrical output of the photosensor is connected to an input of a first pre-amp circuit designed to operate close to a pulse shape and duration of a light pulse from the scintillator material, without signal distortion. The scintillator material includes a set of scintillation layers connected to the wavelength shifting fiber optic light guide media that guide light to the photosensor. Moderator material is applied around the set of scintillation layers increasing detector efficiency.

### CROSS-REFERENCE TO RELATED APPLICATIONS

This application claims priority from prior provisional application 61/208,492 filed on Feb. 25, 2009. This application claims priority from prior provisional application 61/209,194 filed on Mar. 4, 2009. This application claims priority from prior provisional application 61/210,075 filed on Mar. 13, 2009. This application claims priority from prior provisional application 61/210,122 filed on Mar. 13, 2009. This application claims priority from prior provisional application 61/210,234 filed on Mar. 16, 2009. This application claims priority from prior provisional application 61/210,238 filed on Mar. 16, 2009. This application claims priority from prior provisional application 61/211,629 filed on Apr. 1, 2009. This application claims priority from prior provisional application 61/219,111 filed on Jun. 22, 2009. This application claims priority from prior provisional application 61/231,805 filed on Aug. 6, 2009. This application claims priority from prior provisional application 61/238,819 filed on Sep. 1, 2009. This application claims priority from prior provisional application 61/246,299 filed on Sep. 28, 2009. This application claims priority from prior provisional application 61/249,408 filed on Oct. 7, 2009. This application claims priority from prior provisional application 61/257,964 filed on Nov. 4, 2009. This application claims priority from prior provisional application 61/257,968 filed on Nov. 4, 2009. This application claims priority from prior provisional application 61/289,163 filed on Dec. 22, 2009. This application claims priority from prior provisional application 61/293,974 filed on Jan. 11, 2010. This application claims priority from prior provisional application 61/293,993 filed on Jan. 11, 2010. This application is a Continuation-in-part of application Ser. No. 12/483,066 filed on Jun. 11, 2009 and application Ser. No. 12/483,066 which claims priority from prior provisional application 61/131,639 filed on Jun. 11, 2008 and application Ser. No. 12/483,066 which is a continuation-in-part of application Ser. No. 11/624,089 filed on Jan. 17, 2007 and application Ser. No. 12/483,066 which is a continuation-in-part of application Ser. No. 11/852,835 filed on Sep. 10, 2007. This application is continuation-in-part of application Ser. No. 11/564,193 filed on Nov. 28, 2006 and application Ser. No. 11/564,193 which is continuation-in-part of application Ser. No. 11,291,574 filed on Dec. 1, 2005. The entire collective teachings thereof being herein incorporated by reference.

### FIELD OF THE INVENTION

The present invention generally relates to the field of gamma and neutron detection systems, and more particularly relates to high neutron detection efficiency with low gamma cross talk.

### BACKGROUND OF THE INVENTION

The accepted standard in neutron detection has been based on helium-3 (He3). One problem with conventional neutron detectors based on helium-3 is that helium-3 is a natural resource with a very limited supply. These types of detectors and all other known neutron detectors have a gamma rejection of approximately up to 4 gamma pulses in 10,000 pulses detected. Unfortunately, these levels of gamma rejection in conventional neutron detectors can result in too many false positive alarms, indicating that a neutron particle has been detected when in reality a gamma particle was detected. Gamma particles can occur from natural phenomena, such as from the sun, while neutron particles typically indicate a presence of radioactive and/or fissile material. Accurate detection of the occurrence of the neutron particles, without false detection of gamma particles as neutron particles, is critical for monitoring border activities such as during homeland defense and security.

The need for an efficient neutron detector, with little to no false positive alarms due to gamma cross-talk, is critical in many applications such as for homeland security, medical applications, and military applications.

Neutron detectors that are not based on helium-3, generally use lithium 6 or boron 10 dissolved uniformly into a plastic or glass scintillator. One problem with these types of detectors is that they produce much less light per neutron collision event and require much more gain in a photomultiplier tube (PMT). These types of devices also have increased gamma ray sensitivity and use analog techniques to separate gamma from neutron collision events, which typically result in gamma pulse rejection rates of 4 in ten thousand, leaving an unsatisfactory rate of gamma false positives.

An example of a lithium 6 (6Li) neutron detector is described in U.S. Pat. No. 7,244,947 “Neutron detector with layered thermal-neutron scintillator and dual function light guide and thermalizing media” filed on Apr. 13, 2004 by Polichar and Baltgalvis and issued on Jul. 17, 2007. They describe a broad spectrum neutron detector with a thermal neutron sensitive scintillator film interleaved with a hydrogenous thermalizing media. In the Polichar invention, lithium 6 material is combined with Zns (Ag) material and a hydrogenous binder to form a thermalizing neutron detector layer. The neutrons collide with the scintillation layer to create light that is transported to a photosensor. Moderator materials applied between the neutron detector layers thermalize the neutrons. The phosphor and fiber optics both act as efficient gamma detectors.

The 6LiZns(Ag) neutron detector described in U.S. Pat. No. 7,244,947 is described in detail in a Bicron Corporation and the Los Alamos National Laboratory (LANL) report published and released to the public in 2002: “Prototype Neutron-Capture Counter for Fast-Coincidence Assay of Plutonium in Residues”. The Bicron/LANL team described the use of 6LiZnS(Ag) mixture in a hydrogenous binder (moderator material) for each detector layer. Both Polichar and the Bicron/LANL team acknowledge gamma interference that occurs with this type of detector and their need to find a method to separate the neutron and gamma signals.

Analog pulse shape differentiation was discussed as a possible means to address the gamma interference. However, the analog pulse shape differentiation methods available were technically insufficient to correct the gamma interference. The neutron detection efficiencies, per layer, and the gamma interference rates described in the Polichar invention and the Bicron/LANL team report require significant improvements to become a viable product that can compete with conventional neutron detector technologies such as the 3He neutron detector. In addition, the use of moderator material within the 6LiZnS(Ag) detector mixture or between the 6LiAnS(Ag) detector layers causes a loss of thermal neutrons due to absorption by the moderator material reducing the number of available thermal neutrons for detection.

Furthermore, a thesis was published by Mr. Thomas McKnight describing the 6LiZnS(Ag) multi-layer detector using a hydrogenous binder. Again, the neutron detection efficiencies, per layer, and the gamma interference rates described in the McKnight thesis require significant improvements to become a viable product that can compete with conventional neutron detector technologies such as the 3He neutron detector. The McKnight design also uses moderator material within the 6LiZnS(Ag) detector mixture reducing the number of thermal neutrons available for detection due to absorption by the thermalizing moderator material. Analog pulse shape differentiation is discussed as a possible means to address the gamma interference. However, the analog pulse shape differentiation methods available were insufficient to correct the gamma interference.

Current attempts at the detection of special nuclear materials such as highly enriched uranium have had difficulties with the low number of neutrons and the ability to shield low gamma energy that are generated from these materials. Those gamma detectors that can identify highly enriched uranium rely on low energy gamma below 200 Key, which can be easily shielded. Therefore, conventional detectors do not adequately detect special nuclear materials.

### SUMMARY OF THE INVENTION

In one embodiment, a neutron and/or gamma detector system is disclosed. The detector system includes one or more neutron detectors based on Li6, 6LiF, Li3, or a combination thereof, mixed in a binder medium with first scintillator material, that are optically coupled to one or more first wavelength shifting fiber optic light guide media, and have a tapered portion of the one or more first wavelength shifting fiber optic light guide media extending from at least one end of the first scintillator material to guide light from the first scintillator material to a first photosensor at the tapered portion, and wherein an electrical output of the first photosensor is connected to an input of a first pre-amp circuit designed to operate at least as fast as about the pulse rise time and pulse decay time of the first scintillator material.

The detector system can also include one or more gamma detectors based on second scintillator material, that are optically coupled to one or more second wavelength shifting fiber optic light guide media, and have a tapered portion of the second wavelength shifting fiber optic light guide media extending from at least one end of the second scintillator material to guide light from the second scintillator material to a second photosensor at the tapered portion, and wherein an electrical output of the second photosensor is connected to an input of a second pre-amp circuit designed to operate close to the decay time of the second scintillator material.

According to another embodiment, a scintillator detector system comprises an information processing system and at least one neutron and/or gamma detector coupled with the information processing system. The at least one detector comprises a plurality of scintillator layers comprising 6LiF, Li6, or Li3, or a combination thereof, and one or more phosphor materials mixed in a binder medium. A photosensor is electrically coupled to a sensor circuit. At least one light guide medium optically couples the plurality of scintillator layers to the photosensor for coupling light photons emitted from neutron particles interacting with scintillator material in the plurality of scintillator layers into the at least one light guide medium and thereby to the photosensor. The sensor circuit has an electrical signal input electrically coupled to an electrical signal output from the photosensor. A moderator material is disposed externally surrounding the plurality of scintillator layers, and without moderator material being interposed between any two of the plurality of scintillator layers of the at least one neutron and/or gamma detector.

In one embodiment, moderator material is placed in between a plurality of layers of the scintillator material and with a first outer layer of the scintillator material remaining unmoderated by the moderator material, thereby enabling a thermal neutron detector and a fast neutron detector of progressively moderated neutrons.

According to one embodiment, a thermal neutron detector comprises one or more layers of 6LiF mixed in a binder medium with a scintillator material that are optically coupled to one or more fiber optic light guide media. These optical fibers have a tapered portion extending from one or both ends of said layers to guide the light to a narrowed section. The narrow section is coupled to a photosensor. A photosensor output is coupled to a pre-amp circuit designed to drive at its output a detector signal having an optimum electrical signal pulse shape for each of one or more electrical pulses of the detector signal corresponding to one or more light pulses from the scintillation material. The pre-amp circuit operates at least as fast as about the rise time and decay time of light pulses generated from the scintillator material by collision interaction with neutron particles and gamma particles. This enables electrical pulses corresponding to light pulses emitted by the scintillation material to be delivered without distortion (closely tracking the pulse shape and duration of pulses in an electrical sensor signal from the photosensor) to a set of electronics that perform analog to digital conversion. Digital signal processing hardware, operating according to firmware or software, processes the digital signals representing the electrical pulses of the detector signal to differentiate one or more digital gamma pulses from one or more digital neutron pulses, for elimination or separation (or filtering) of gamma signal interference from neutron detection.

According to one embodiment, a programmable gain and offset of a sensor interface unit analog front end presents electrical pulse signals to a high speed/high resolution digitizer (analog-to-digital conversion circuit) that feeds digitized signal representing the electrical pulse signals to a Field programmable Gate Array (FPGA) that includes hardware real-time pulse digital signal processor (DSP) programmable filters.

The high speed analog-to-digital conversion circuit, according to one embodiment, can plot the fastest pulse with 15 or more points of high resolution data.

One or more of the following programmable filters are used to eliminate noise and most gamma pulses:

A) a LLD (low level discriminator) or noise canceller as well as employing a pulse rise time filter.

B) Pulses must meet a minimum rise time to be considered for analysis.

C) The next stage of signal processing occurs at a pulse width filter, which measures the duration of the pulse at a point where the shape widens when the pulse originates from a neutron reaction. Gamma pulses have a clean and rapid decay, whereas neutron interaction with the detector produces an extended fall time.

In one embodiment, the detector is designed with a bundle of fiber optic light guide media having one narrowed end optically coupled to an optical signal input of a photosensor, and with a reflective, or a non-reflective light absorptive material, terminating an opposing end of the fiber optic light guide media.

In another embodiment, the moderator material for the thermal neutron detector system is designed around the thermal neutron detector, and moderator material is not used within the detector mixture or between the layers. This structure provides a designed level of moderator interaction with the neutrons before they are introduced to the thermal neutron detector. Each of the thermal neutron detector layers has an efficiency level for the detection of thermal neutrons. The multiple layers act to increase the neutron detector efficiency. The elimination of moderator materials within the detector layers, and/or between the detector layers, reduces neutron absorption and increases the number of thermal neutrons available for detection.

In another embodiment, the moderator materials are designed and applied within the thermal neutron detector system to enable the differential detection of fast neutrons and thermal neutrons. The thermal neutron detector when exposed without moderator material is a simple thermal neutron detector. A thermal neutron detector surrounded by moderator material can be designed to detect fast neutrons within a thermal energy range due to the density and thickness of the moderator selected.

In another embodiment, the moderator material can be designed to enable the thermal neutron detector to detect fast neutrons thermalized to a specific energy range. Multiple layers of moderator and thermal neutron detectors can be arranged to detect different stages of thermalized neutrons providing energy information on the neutrons detected at each layer.

According to one embodiment, staggered multiple layers of optical fiber strands and detector materials can be sandwiched together, where a first set of parallel fiber strands in a first fiber layer are disposed on top of detector material layer and which is disposed on top of a second set of parallel fiber strands in a second fiber layer. The first set of parallel fiber strands is arranged in a staggered orientation relative to the second set of parallel fiber strands. By staggering the two sets of parallel fiber layers by a portion of the diameter of a fiber (such as by one half of the diameter of a fiber), it locates the sandwiched parallel fibers closer together (with the detector material in between) and thereby more likely to couple light photons into the fibers when neutrons interact with the detection materials.

A moderator is designed to surround the thermal neutron detector. An optimum moderator design is applied to slow the fast neutrons to a thermal energy to enable the best efficiency for thermal neutron detection. An example of a moderator design comprises two inch thick HPGE moderator material to surround the neutron detector.

A light protective covering, according to one embodiment, is applied to the detector to eliminate light intrusion into the detector area. Thermistors may be applied to monitor the operating temperature of the detector components to enable automated or manual calibration of the detector output signals.

A light shield can be applied to the outer shell of the detector layers to eliminate outside light interference by using an opaque shrink wrap as a light shield around the detector area up to and/or covering a portion of the photosensor. Another method for light shielding could include an opaque covering applied as a liquid that dries onto the detector and acts as a light shield around the detector area up to and/or covering a portion of the photosensor.

In another embodiment, a neutron detector is surrounded by neutron absorbing material, except at a tunnel opening inside the neutron absorbing material defining a focal view in front of the neutron detector. The neutron absorbing material limits traveling neutrons from making contact with the neutron detector except for traveling neutrons that are coming from a specific direction defined by the focal view in front of the at least one neutron detector.

In one embodiment, a plurality of neutron detectors, each having a focal view, are placed and oriented in at least one of: a one sided array, a multisided array, a horizontal array, and a vertical array, and that collectively can inspect for the presence of any of a fissile material, a shielded fissile material, highly enriched uranium, and shielded highly enriched uranium.

According to one embodiment, an array of the neutron detectors is deployed in a gamma and/or neutron detector system for the inspection of shipping containers.

In another embodiment, one or more neutron detectors are spatially distributed between moderator material. Optionally, scintillator material in a neutron detector can comprise a plurality of scintillation layers that are spatially distributed interposed between moderator material.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating an example of a detector system according to one embodiment of the present invention;

FIG. 2 is block diagram of a gamma and neutron detector according to one embodiment of the present invention;

FIG. 3 is a schematic illustrating a neutron detector and its supporting components according to one embodiment of the present invention;

FIG. 4 is a circuit diagram for a pre-amp according to one embodiment of the present invention;

FIG. 5 is top-planar view of a neutron detector according to one embodiment of the present invention;

FIG. 6 is a graph illustrating a neutron pulse generated from a neutron detector according to one embodiment of the present invention;

FIG. 7 is a graph illustrating a gamma pulse generated from a neutron detector according to one embodiment of the present invention;

FIG. 8 is a block diagram illustrating a detailed view of an information processing system according to one embodiment of the present invention;

FIG. 9 is a block diagram illustrating a gamma detector element according to one embodiment of the present invention;

FIG. 10 is a block diagram illustrating a gamma and neutron detector according to one embodiment of the present invention;

FIG. 11 is a block diagram illustrating an example of progressive moderators in a neutron detector.

FIG. 12 is a block diagram illustrating a neutron detector with a photosensor reference according to one embodiment of the present invention;

FIG. 13 is a circuit diagram illustrating a temperature compensation circuit for the photosensor reference shown in FIG. 12.

FIG. 14 is a block diagram illustrating an example of a neutron detector with photosensor connections according to one embodiment of the present invention;

FIG. 15 is a block diagram illustrating a second example of a neutron detector with photosensor connections;

FIG. 16 is a block diagram illustrating a third example of a neutron detector with photosensor connections;

FIG. 17 is a block diagram illustrating a fourth example of a neutron detector with photosensor connections;

FIG. 18 is a block diagram illustrating a neutron detector and moderator in a spatial distribution arrangement according to one embodiment of the present invention;

FIG. 19 is a block diagram illustrating a focal neutron detector according to one embodiment of the present invention;

FIG. 20 is a block diagram illustrating an example of a focal neutron detector deployed as a container inspection module.

FIG. 21 is a block diagram illustrating an array of focal neutron detectors deployed in a container inspection system.

FIG. 22 is a an image showing an example of a gamma and/or neutron detector according to one embodiment of the present invention; and

FIGS. 23, 24, and 25, are diagrams showing alternative configurations of detectors, according to various embodiments of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and other similar terms as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Neutron Detector System

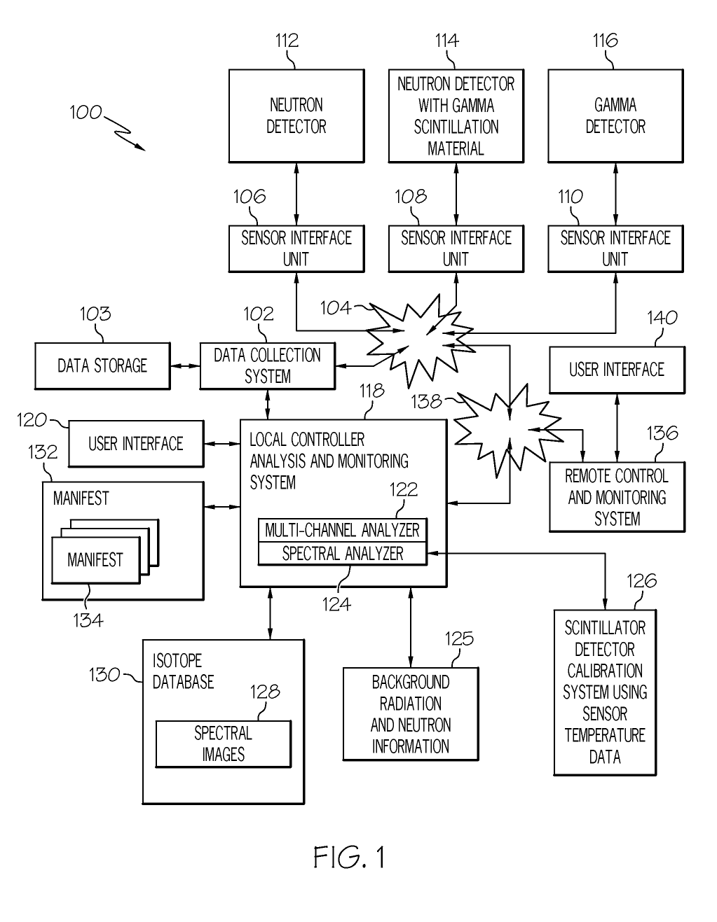

FIG. 1 is a block diagram illustrating one example of a neutron detector system 100 according to one embodiment of the present invention. In particular, FIG. 1 shows that a data collection system 102 is communicatively coupled via cabling, wireless communication link, and/or other communication links 104 with one or more high speed sensor interface units (SIU) 106, 108, 110. The high speed sensor interface units 106, 108, 110 each support one or more high speed scintillation (or scintillator) detectors, which in one embodiment comprise a neutron detector 112, a neutron detector with gamma scintillation material 114, and a gamma detector 116. Each of the one or more SIUs 106, 108, 110 performs analog to digital conversion of the signals received from the high speed scintillation detectors 112, 114, 116. An SIU 106, 108, 110 performs digital pulse discrimination based on one or more of the following: pulse height, pulse rise-time, pulse fall-time, pulse-width, pulse peak, and pulse pile-up filter.

The data collection system 110, in one embodiment, includes an information processing system (not shown) comprising data communication interfaces (not shown) for interfacing with each of the one or more SIUs 124. The data collection system 110 is also communicatively coupled to a data storage unit 103 for storing the data received from the SIUs 106, 108, 110. The data communication interfaces collect signals from each of the one or more high speed scintillation detectors such as the neutron pulse device(s) 112, 114 and the gamma detector 116. The collected signals, in this example, represent detailed spectral data from each sensor device 112, 114, 116 that has detected radiation. In one embodiment, the SIU(s) 124 can discriminate between gamma pulses and neutron pulses in a neutron detector 112. The gamma pulses can be counted or discarded. Also, the SIU(s) 106, 108, 110 can discriminate between gamma pulses and neutron pulses in a neutron detector with gamma scintillation 114. The gamma pulses can be counted, processed for spectral information, or discarded.

The data collection system 102, in one embodiment, is modular in design and can be used specifically for radiation detection and identification, or for data collection for explosives and special materials detection and identification. The data collection system 102 is communicatively coupled with a local controller and monitor system 118. The local system 118 comprises an information processing system (not shown) that includes a computer system(s), memory, storage, and a user interface 120 such a display on a monitor and/or a keyboard, and/or other user input/output devices. In this embodiment, the local system 118 also includes a multi-channel analyzer 122 and a spectral analyzer 124.

The multi-channel analyzer (MCA) 122 can be deployed in the one or more SIUs 106, 108, 110 or as a separate unit 122 and comprises a device (not shown) composed of many single channel analyzers (SCA). The single channel analyzer interrogates analog signals received from the individual radiation detectors 112, 114, 116 and determines whether the specific energy range of the received signal is equal to the range identified by the single channel. If the energy received is within the SCA, the SCA counter is updated. Over time, the SCA counts are accumulated. At a specific time interval, a multi-channel analyzer 122 includes a number of SCA counts, which result in the creation of a histogram. The histogram represents the spectral image of the radiation that is present. The MCA 122, according to one example, uses analog to digital converters combined with computer memory that is equivalent to thousands of SCAs and counters and is dramatically more powerful and less expensive than deploying the same or even a lesser number of SCAs.

A scintillation calibration system 126 uses temperature references from a scintillation crystal to operate calibration measures for each of the one or more high speed scintillation detectors 112, 114, 116. These calibration measures can be adjustments to the voltage supplied to the high speed scintillation detector, adjustments to the high speed scintillation detector analog interface, and or software adjustments to the spectral data from the high speed scintillation detector 112, 114, 116. For example, high speed scintillator detector 112, 114, 116, can utilize a temperature sensor in contact with the scintillation crystal and/or both in the photosensor of the detector to determine the specific operating temperature of the crystal. The specific operating temperature can be used as a reference to calibrate the high speed scintillation detector. The detector crystal and the photosensor both may have impacts on detector signal calibration from changing temperatures. A temperature chamber can be used to track the calibration changes of an individual detector, photosensor or mated pair across a range of temperatures. The calibration characteristics are then mapped and used as a reference against temperatures experienced in operation.

Histograms representing spectral images 128 are used by the spectral analysis system 124 to identify fissile materials or isotopes that are present in an area and/or object being monitored. One of the functions performed by the local controller 118 is spectral analysis, via the spectral analyzer 124, to identify the one or more isotopes, explosives, or special materials contained in a container under examination. In one embodiment, background radiation is gathered to enable background radiation subtraction. Background neutron activity is also gathered to enable background neutron subtraction. This can be performed using static background acquisition techniques and dynamic background acquisition techniques. Background subtraction is performed because there are gamma and neutron energies all around. These normally occurring gamma and neutrons can interfere with the detection of the presence of (and identifying) isotopes and nuclear materials. In addition, there can be additional materials other than the target giving off gammas and or neutrons. Therefore, the background gamma and neutron rate is identified and a subtraction of this background is performed to allow for an effective detection and identification of small amounts of radiation of nuclear material. This background and neutron information 125 is then passed to the local control analysis and monitoring system 118 so that precise and accurate monitoring can be performed without being hindered by background radiation. The dynamic background analysis technique used to perform background subtraction enables the neutron detector system 100 to operate at approximately 4 sigma producing an accuracy of detection above background noise of 99.999%.

After background subtraction, with respect to radiation detection, the spectral analyzer 124 compares one or more spectral images of the radiation present to known isotopes that are represented by one or more spectral images 128 stored in the isotope database 130. By capturing multiple variations of spectral data for each isotope there are numerous images that can be compared to one or more spectral images of the radiation present. The isotope database 130 holds the one or more spectral images 128 of each isotope to be identified. These multiple spectral images represent various levels of acquisition of spectral radiation data so isotopes can be compared and identified using various amounts of spectral data available from the one or more sensors. Whether there are small amounts (or large amounts) of data acquired from the sensor, the spectral analysis system 124 compares the acquired radiation data from the sensor to one or more spectral images for each isotope to be identified. This significantly enhances the reliability and efficiency of matching acquired spectral image data from the sensor to spectral image data of each possible isotope to be identified.

Once one or more possible isotopes are determined to be present in the radiation detected by the sensor(s) 112, 114, 116, the local controller 118 can compare the isotope mix against possible materials, goods, and/or products that may be present in the container under examination. Additionally, a manifest database 132 includes a detailed description (e.g., manifests 134) of the contents of a container that is to be examined. The manifest 134 can be referred to by the local controller 118 to determine whether the possible materials, goods, and/or products, contained in the container match the expected authorized materials, goods, and/or products, described in the manifest for the particular container under examination. This matching process, according to one embodiment of the present invention, is significantly more efficient and reliable than any container contents monitoring process in the past.

The spectral analysis system 124, according to one embodiment, includes an information processing system (not shown) and software that analyzes the data collected and identifies the isotopes that are present. The spectral analysis software is able to utilize more than one method to provide multi-confirmation of the isotopes identified. Should more than one isotope be present, the system 124 identifies the ratio of each isotope present. There are many industry examples of methods that can be used for spectral analysis for fissile material detection and isotope identification.

The data collection system 102 can also be communicatively coupled with a remote control and monitoring system 136 via at least one network 138. The remote system 136 comprises at least one information processing system (not shown) that has a computer, memory, storage, and a user interface 140 such as a display on a monitor and a keyboard, or other user input/output device. The networks 104, 138 can be the same networks, comprise any number of local area networks and/or wide area networks. The networks 104, 138 can include wired and/or wireless communication networks. The user interface 140 allows remotely located service or supervisory personnel to operate the local system 118; to monitor the status of shipping container verification by the collection of sensor units 106, 108, 110 deployed on the frame structure; and perform the operations/functions discussed above from a remote location.

Neutron Detector

The following is a more detailed discussion of a neutron detector such as the neutron detector 112 or 114 of FIG. 1. The neutron detector of various embodiments of the present invention provides high levels of efficiency with near zero gamma cross talk. The neutron detector is a high efficiency neutron detector that uses a scintillator medium coupled with fiber optic light guides with high speed analog to digital conversion and digital electronics providing digital pulse shape discrimination for near zero gamma cross talk.

The neutron detector of various embodiments of the present invention is important to a wide variety of applications: such as portal detectors, e.g., devices in which a person or object is passed through for neutron and gamma detection, fissile material location devices, neutron based imaging systems, hand held, mobile and fixed deployments for neutron detectors. The neutron detector in various embodiments of the present invention, for example, can utilize the Systems Integration Module for CBRNE sensors discussed in the commonly owned U.S. Pat. No. 7,269,527, which is incorporated by reference herein in its entirety.

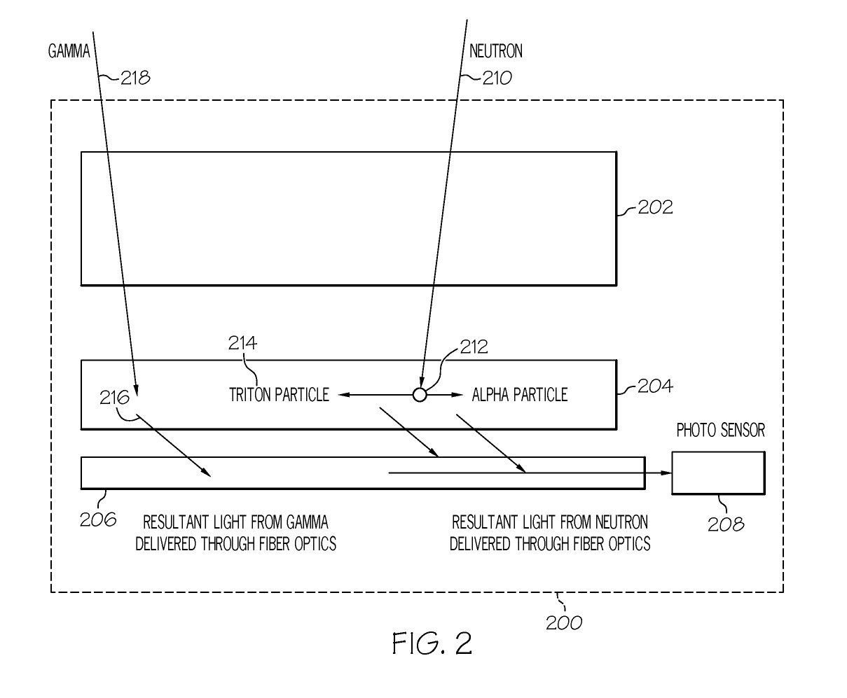

FIG. 2 is a block diagram illustrating a more detailed view of a neutron detector 200 according to one embodiment of the present. In particular, FIG. 2 shows that the neutron detector 200 comprises a neutron moderator material 202 such as polyethylene and scintillation material 204 which can comprise, in this example, 6Li of 6LiF or any similar substance. In one embodiment, the 6LiF is mixed in a hydrogenous binder medium with a scintillation (or scintillator) material 204 and has a thickness of about (but not limited to) 0.1 mm to about 0.5 mm. The scintillator material 204, in one embodiment can comprise one or more materials such as (but not limited to) ZnS, ZnS(Ag), or NaI(Tl). One or more of these materials give the neutron detector 200 resolution for gamma signals that can be used in spectroscope analysis.

The moderator material 202 acts as a protective layer that does not allow light into the detector 200. Alternatively, a separate light shield can be applied to the outer shell of the detector layers to eliminate outside light interference. Also, the moderator material 202 can comprise interposing plastic layers that act as wavelength shifters. According to one embodiment, at least one plastic layer is adjacent to (and optionally contacting) the at least one light guide medium. According to one embodiment, the at least one light guide medium at the at least one scintillator layer is substantially surrounded by plastic that acts as a wavelength shifter. That is, the plastic layers (and/or optionally plastic substantially surrounding the light guide medium at the at least one scintillator layer) act(s) as wavelength shifter(s) that receive light photons emitted from the at least one scintillator layer (from neutron particles interacting with the at least one scintillator layer) and couple these photons into the at least one light guide medium. According to one embodiment, the at least one light guide medium at the at least one scintillator layer comprises fiber optic media that acts as a wavelength shifter (e.g., wave shifting fiber). This provides a more efficient means of collecting light out the end of the at least one light guide medium, such as when the light enters from substantially normal incidence from the outside of the at least one light guide medium.

An example of a moderator material that can be used with the present invention comprises dense polyethylene. The optimum moderator configuration, in one embodiment, is estimated at 2 inches of dense polyethylene. The moderator material 202 thermalizes the fast neutrons before they enter the detector 200. This thermalization of the fast neutrons allows the thermal neutron detector to perform at an optimum efficiency. Thermal neutron sensitive scintillator material that is useful in the fabrication of a neutron detector such as the detector 200 of FIG. 2 includes, but is not limited to 6Li—ZnS, 10BN, and other thin layers of materials that release high energy He or H particles in neutron capture reactions. Such materials can be 6Li- or 10B-enriched ZnS, 10BN, or other phosphors that contain Li or B as an additive. Examples of such scintillator plastics include BC 480, BC 482, and BC 484, all available from the French company St. Gobain, SA.

The neutron detector 200 also comprises a light carrying medium 206 such as fiber optics that is coupled to a photosensor 208. The photosensor 508, in one embodiment, comprises a photomultiplier tube or an avalanche diode. The 6Li or 6LiF and scintillator material 204 is optically coupled to the light guide medium 206. The light guide medium 206, in one embodiment, includes a tapered portion that extends from one or both ends of the scintillation layer 204 to guide the light to a narrowed section. This narrowed section is optically coupled to the photosensor 208 at the tapered portion. The photosensor, such as the photomultiplier tube, is tuned to operate close to the light frequency of the light photons generated from the scintillation material and carried by the light guide medium.

The scintillation material 204 is excited by an incident neutron 210 that is slowed by the moderator material 202. The incident material reacts by emitting an alpha particle 212 and triton 214 into the neighboring scintillation material 204, which can be, in this example, a phosphor material. The scintillation material 204 is energized by this interaction and releases the energy as photons (light) 216. The photons 216 travel into the light carrying medium 206 and are guided to the ends of the medium 206 and exit into the photosensor 208. In one embodiment, the light guide medium 206 is a wavelength shifter. The wavelength shifter shifts blue or UV light to a wavelength that matches the sensitivity of a photosensor 208, avalanche sensor, or diode sensor. It should be noted that a gamma particle 218 can also hit the scintillation material 204, which creates photons 216 that are received by the photosensor 208.

The neutron detector 200 provides significant improvements in form and function over a helium-3 neutron detector. The neutron detector 200 is able to be shaped into a desired form. For example, the scintillator layer(s) and moderator material can be curved and configured for up to a 360 degree effective detection angle of incidence. The at least one scintillator layer and moderator material can be flat and designed as a detector panel. The neutron detector 200 comprises a uniform efficiency across the detector area. The neutron detector 200 can comprise multiple layers to create an efficiency which is substantially close to 100%.

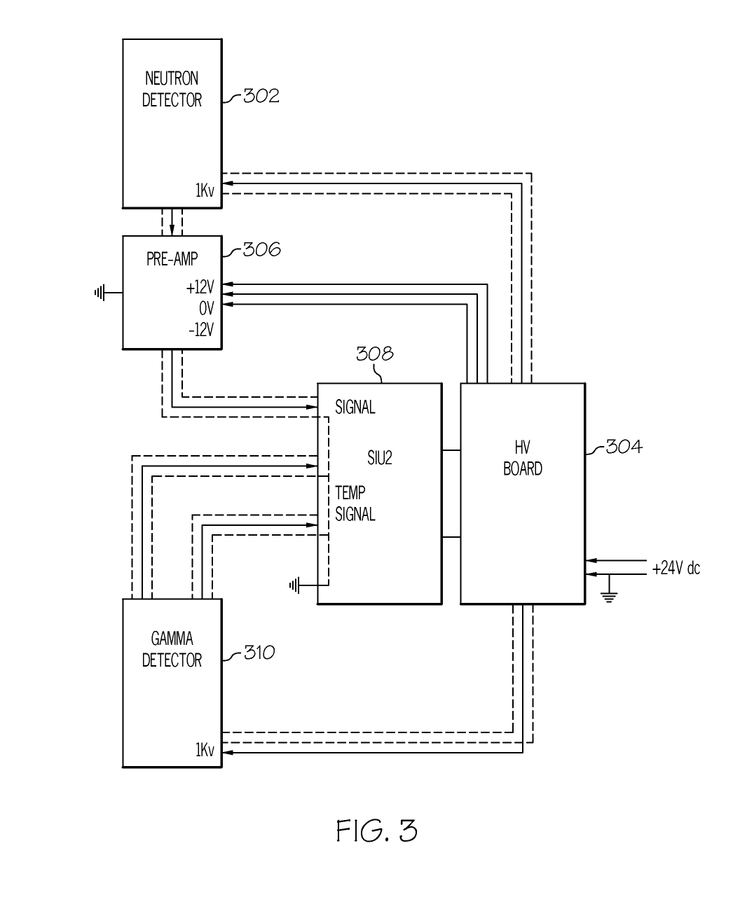

FIG. 3 is a schematic that illustrates various components that are used to support a neutron detector such as the neutron detectors 112, 114 shown in FIG. 1. In one embodiment, the various electrical components shown in FIG. 3 provide a signal sampling rate of 50 million samples per second or faster. In particular, FIG. 3 shows a neutron detector 302 electrically coupled to a high voltage board 304, which provides power to the neutron detector 302. The neutron detector 302 generates analog signals that are received by a pre-amp component 306, which is also electrically coupled to the high voltage board 304. The pre-amp 306, in one embodiment, drives the detector signal processing rate close to the decay time of the scintillator material in the detector 302. This enables pulses to be delivered without distortion to a set of electronics that perform analog to digital conversion, such as the SIU 308. The SIU 308 is electrically coupled to the pre-amp 306, high voltage board 304, and a gamma detector 310 (in this embodiment). The analog signals from the neutron detector 302 are processed by the pre-amp 306 and sent to the SIU unit 308. The SIU 308 performs an analog-to-digital conversion process on the neutron detector signals received from the pre-amp 306 and also performs additional processing, which has been discussed above.

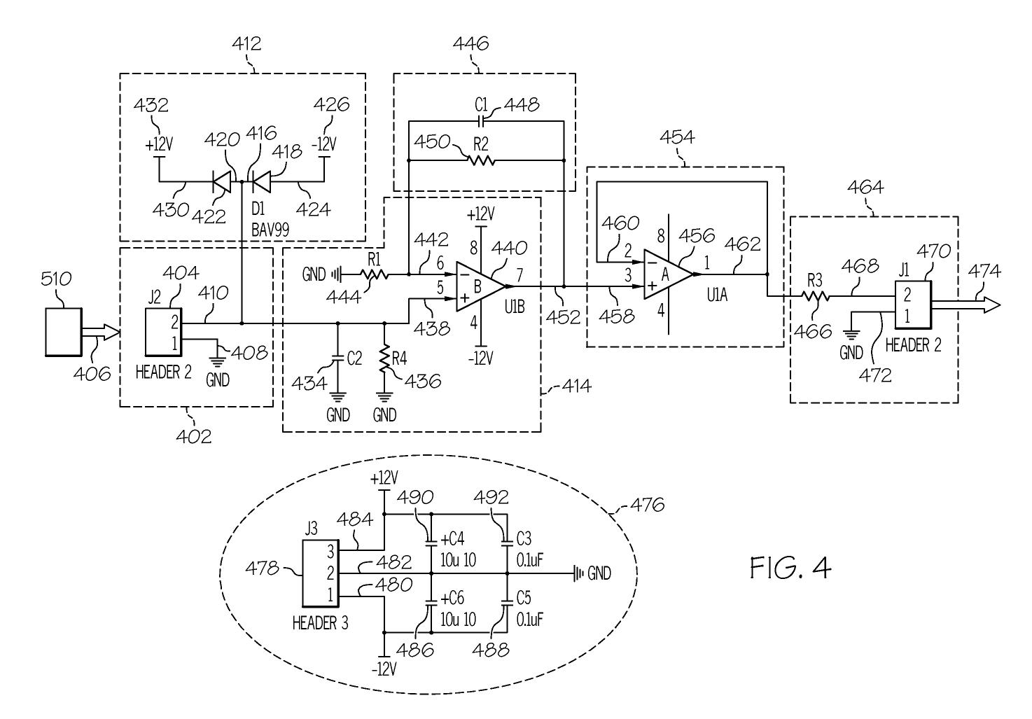

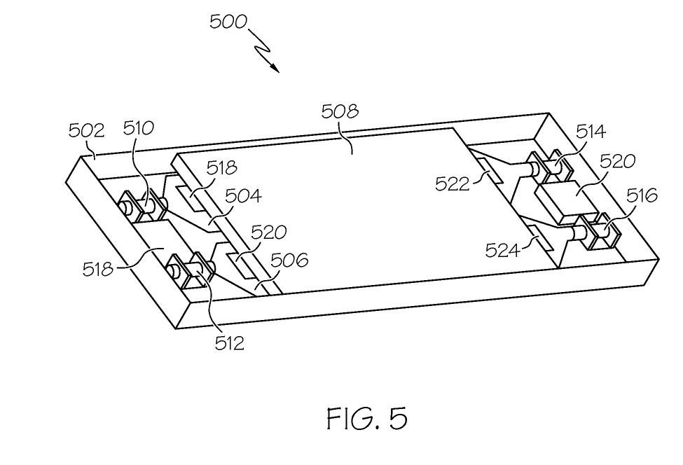

FIG. 4 shows a more detailed schematic of the pre-amp component 306. The pre-amp component 306 shown in FIGS. 3 and 4 is enhanced to reduce the pulse stretching and distortion typically occurring with commercial preamps. The pre-amp 306 of FIGS. 3 and 4 removes any decay time constant introduced by capacitive and or inductive effects on the amplifier circuit. For example, the impedance, in one embodiment, is lowered on the input of the preamp that is attached to the output of a photomultiplier tube 510, 512, 514, 516 (FIG. 5) to maintain the integrity of the pulse shape and with the preamp output signal gain raised to strengthen the signal.

The pre-amp circuit 306 of FIG. 4 includes a first node 402 comprising a header block 404 that is electrically coupled to the output 406 of the neutron detector photomultiplier 510 as shown in FIG. 4. A first output 408 of the header block 404 is electrically coupled to ground, while a second output 410 of the header block 404 is electrically coupled a second node 412 and a third node 414. In particular, the second output 410 of the header block 404 is electrically coupled to an output 416 of a first diode 418 in the second node 412 and an input 420 of a second diode 422. The input 424 of the first diode 418 is electrically coupled to a voltage source 426. The output of the first diode is electrically coupled to the input of the second diode. The output 440 of the second diode 422 is electrically coupled to a second voltage source 442.

The third node 414 comprises a capacitor 444 electrically coupled to ground and a resistor 436 that is also electrically coupled to ground. The capacitor 444 and the resistor 436 are electrically coupled to the second output 410 of the header block 406 and to a first input 438 of an amplifier 440. A second input 442 of the amplifier 440 is electrically coupled to a resistor 444 to ground. The amplifier 440 is also electrically coupled to a power source as well. A fourth node 446 is electrically coupled to the second input 442 of the amplifier in the third node 414. The fourth node 446 includes a capacitor 448 and a resistor 450 electrically coupled in parallel, where each of the capacitor 448 and resistor 450 is electrically coupled to the second input 442 of the amplifier 440 in the third node 414 and the output 452 of the amplifier 440 in the third node 414.

The output 452 of the amplifier 440 in the third node 414 is electrically coupled to a fifth node 454 comprising another amplifier 456. In particular, the output 452 of the amplifier 440 of the third node 414 is electrically coupled to a first input 458 of the amplifier 456 in the fifth node 454. A second output 460 of the amplifier 456 in the fifth node 454 is electrically coupled to the output 462 of the amplifier 456. The output 462 of the amplifier 456 is electrically coupled to a sixth node 464. In particular, the output 462 of the amplifier 456 in the fifth node 454 is electrically coupled to a resistor 466 in the sixth node 464, which is electrically coupled to a first input 468 of another header block 470. A second input 472 of the header block 470 is electrically coupled to ground. An output 474 of the header block 470 is electrically coupled to an analog-to-digital converter such as an SIU discussed above.

The pre-amp circuit 306 of FIG. 4 also includes a seventh node 476 comprising a header block 478. A first 480 and third 484 output of the third header block 478 is electrically coupled to a respective voltage source. A second output 482 is electrically coupled to ground. The first output 480 is electrically coupled to a first 486 and second 488 capacitor, which are electrically coupled to the second output 482. The third output 484 is electrically coupled to a third 490 and a fourth 492 capacitor, that are electrically coupled to the second output 482 as well.

FIG. 5 shows a top planar cross-sectional view of a neutron detector component 500 that can be implemented in the system of FIG. 1. In particular, FIG. 5 shows a housing 502 comprising one or more thermal neutron detectors 504, 506. The thermal neutron detector 504, 506, in this embodiment, is wrapped in a moderator material 508. Photomultiplier tubes 510, 512, 514, 516 are situated on the outer ends of the thermal neutron detectors 504, 506. Each of the photomultiplier tubes 510, 512, 515, 516 is coupled to a preamp 518, 520, 542, 544. Each preamp 518, 520, 522, 524 is electrically coupled to a sensor interface unit 556, 528. Each preamp 518 can be electrically coupled to its own SIU 526, 528 or to an SIU 526, 528 that is common to another preamp 520, as shown in FIG. 5.

The thermal neutron detector 504, 506 is wrapped in a moderator material 508 comprising moderator efficiencies that present a greater number of thermalized neutrons to the detector 504, 506 as compared to conventional neutron detectors. A neutron moderator is a medium that reduces the speed of fast neutrons, thereby turning fast neutrons into thermal neutrons that are capable of sustaining a nuclear chain reaction involving, for example, uranium-235. Commonly used moderators include regular (light) water (currently used in about 75% of the world's nuclear reactors), solid graphite (currently used in about 20% of nuclear reactors), and heavy water (currently used in about 5% of reactors). Beryllium has also been used in some experimental types, and hydrocarbons have been suggested as another possibility.

The following is a non-exhaustive list of moderator materials that are applicable to one or more embodiments of the present invention. Hydrogen, as in ordinary water (“light water”), in light water reactors. The reactors require enriched uranium to operate. There are also proposals to use the compound formed by the chemical reaction of metallic uranium and hydrogen (uranium hydride—UH₃) as a combination fuel and moderator in a new type of reactor. Hydrogen is also used in the form of cryogenic liquid methane and sometimes liquid hydrogen as a cold neutron source in some research reactors: yielding a Maxwell-Boltzmann distribution for the neutrons whose maximum is shifted to much lower energies. Deuterium, in the form of heavy water, in heavy water reactors, e.g. CANDU. Reactors moderated with heavy water can use unenriched natural uranium. Carbon, in the form of reactor-grade graphite or pyrolytic carbon, used in e.g. RBMK and pebble-bed reactors, or in compounds, e.g. carbon dioxide. Lower-temperature reactors are susceptible to buildup of Wigner energy in the material. Like deuterium-moderated reactors, some of these reactors can use unenriched natural uranium. Graphite is also deliberately allowed to be heated to around 2000 K or higher in some research reactors to produce a hot neutron source: giving a Maxwell-Boltzmann distribution whose maximum is spread out to generate higher energy neutrons. Beryllium, in the form of metal, is typically expensive and toxic, and so its use is limited. Lithium-7, in the form of a fluoride salt, typically in conjunction with beryllium fluoride salt (FLiBe) is the most common type of moderator in a Molten Salt Reactor. Other light-nuclei materials are unsuitable for various reasons. Helium is a gas and is not possible to achieve its sufficient density, lithium-6 and boron absorb neutrons.

In addition to the neutron detector configuration shown in FIG. 5, a multi-layered neutron detector can also be used in one or more embodiments of the present invention. In this embodiment a full neutron detector is constructed with moderator material and multiple layers of the neutron detector device. A second full neutron detector with moderator material is positioned directly behind the first to create a multilayered neutron detector system. In another embodiment, moderator materials are interleaved between one or more of the detector layers. Additional moderator materials may be applied surrounding this detector configuration.

Also, one or more embodiments of the present invention can be utilized as a passive neutron detection system for shielded nuclear materials such as highly enriched uranium. In this embodiment, the neutron detector discussed above provides strong detection capabilities for shielded nuclear material. Additional detector configurations may be added to increase the shielded nuclear materials detection capability. The thermal neutron detector system 100 may also add one or more fast neutron detectors designed as a high performance detector with modified preamp and connection to the sensor interface unit for high speed digital data analysis. The sandwich neutron detector design discussed above can be used to increase the detection capability of shielded nuclear materials. A more efficient moderator material may be developed to increase the number of fast neutrons that are thermalized and presented to the neutron detector. Also, the neutron detector of the various embodiments of the present invention can use moderator materials for a portion of the detector surface area to enable detection of thermal neutrons and to convert fast neutrons to thermal neutrons.

Experimental Information

Based on the processing speeds and features of the proprietary sensor interface unit (SIU) 106, 108, 100, (which is commercially available from Innovative American Technologies, Inc.) experiments were performed with gamma/neutron pulse differentiation techniques. The various embodiments of the present invention were able to effectively eliminate the gamma detections without impacting the neutron detection efficiencies. After extensive testing, it was found that the conventional multichannel analyzers and detector electronics in the industry with primarily applied features on the analog side of the electronics ran at slower speeds than the neutron detector pulse. The pulses were subsequently altered (slowed down) to address the slower MCA electronics. Slowing the pulse distorts the shape of the pulse, which causes problems in differentiating between gamma and neutron pulses. Also, when the electronics extend the pulse, an opportunity is created for pulse stacking to occur, where the overall envelope is larger than that of a single neutron pulse, rendering the pulse shape analysis unreliable at best.

Therefore, the neutron pre-amp 306 (FIG. 3) according to one or more embodiments of the present invention is enhanced to reduce the pulse stretching and distortion typically occurring with commercial pre-amps. That is, the pre-amp circuit is configured to operate substantially close to a decay time of the scintillator layer when interacting with neutrons, and without adding further extension (distortion) to the electrical signal output from the pre-amp. The pre-amp 306 removes decay time constant that may be introduced by capacitive and or inductive effects on the amplifier circuit. For example, the impedance can be lowered on the input of the pre-amp attached to the output from the photomultiplier tube to maintain the integrity of the pulse shape, and optionally with the pre-amp output gain raised to strengthen the output signal.

The neutron detector 200 improves the gamma discrimination by utilizing the preamp 306 to keep the pulse as close as possible to its original duration and shape with a pulse duration of approximately 250 nanoseconds (in one embodiment). This improves linearity and increases the ability to process more counts per second, especially in a random burst where multiple gamma and/or neutron pulse events may be blurred into one pulse. The programmable gain and offset of the SIU 106, 108, 110 analog front end presents the pulse signal to a 50 MHz high speed/high resolution digitizer which feeds the Field programmable Gate Array (FPGA) that includes proprietary hardware real-time Pulse DSP programmable filters from Innovative American Technology (IAT), Inc. The high speed analog-to-digital conversion circuit (within the SIUs) can sample the fastest pulse with approximately 15 points of high resolution data. These programmable filters are used in the second stage of signal processing to eliminate noise and most gamma pulses via a LLD (low level discriminator) or noise canceller as well as employing a pulse rise time filter. Pulses must meet a minimum rise time to be considered for analysis. The next stage of signal processing occurs at a pulse width filter, which measures the duration of the pulse at a point where the shape widens when the pulse originates from a neutron reaction. Gamma pulses have a clean and rapid decay, whereas neutron interaction with the detector produces an extended fall time.

The result of the above signal processing is that the speed of the STU 106, 108, 110 system hardware and embedded processor clearly differentiates between a neutron pulse and a gamma pulse. This enables the neutron detector system 100 to eliminate nearly 100% of the gamma pulses received by the neutron detector without impacting the neutron detector efficiencies. Subsequent testing at various laboratories supported zero gamma detection (zero gamma cross-talk) under high gamma count rates and high gamma energy levels. For example, testing with Cs137 in the inventor's lab (16 micro-curies) placed directly in front of the neutron detector, using the IAT commercially available SIU and RTIS application components, provided the following results: 1/10,000,000 (one in ten million) gamma pulse counts using Cs137 for the test. The neutron detector 200 was deployed using the IAT detection, background subtraction and spectral analysis system software operating at 4.2649 sigma which translates to a false positive rate of 1/100,000 (one in one hundred thousand) or an accuracy rate of 99.999%.

An Example of a Discrimination Process

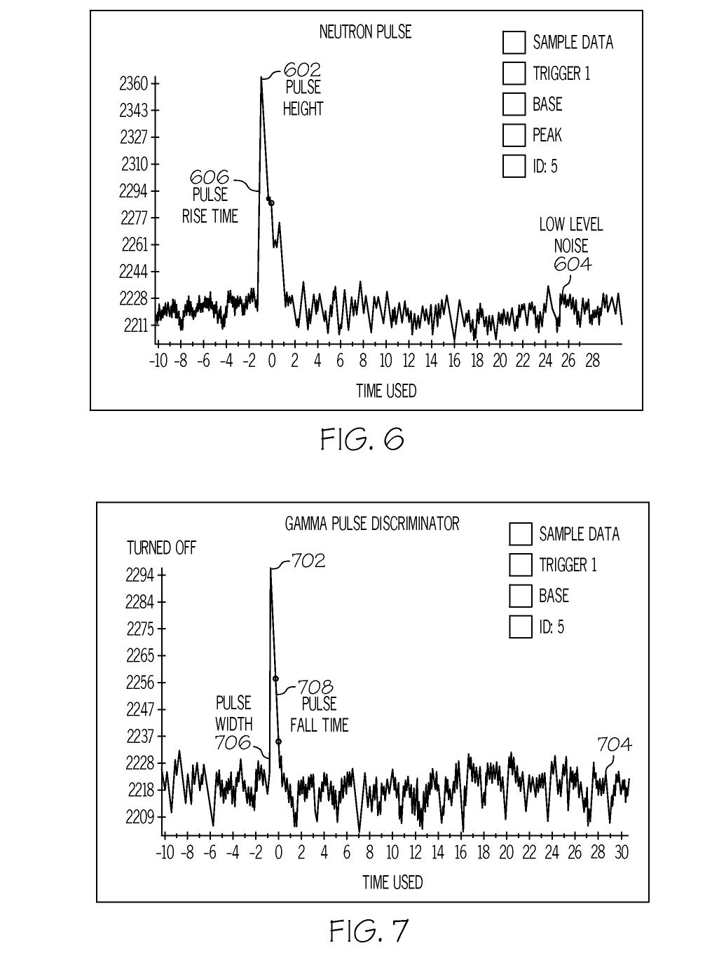

FIGS. 6 and 7 show a neutron pulse and a separate gamma pulse, respectively, generated from the neutron detector 200 and digitally converted for processing. The neutron pulse in FIG. 6 represents a pure pulse without distortion, meets the pulse height 602 requirements, is above the noise threshold filter 604, meets the pulse rise-time requirements 604, and has a much wider base than the example gamma pulse in FIG. 7, accordingly identifying the pulse as a neutron pulse. The gamma pulse in FIG. 7, meets the pulse height requirement, is above the noise threshold filter, does not meet the pulse rise width 702 requirement, and is therefore eliminated through pulse shape discrimination (which comprise discrimination by any one or more of the following signal features: pulse height, pulse width, pulse rise time, and/or pulse fall time).

Therefore, the neutron detector 200 provides various improvements over conventional helium-e type detectors. For example, with respect to the neutron detector 200, the pulse height allows the detector system 100 to provide better discrimination against lower energy gamma. The Li+n reaction in the neutron detector 200 produces 4.78 Mev pulse. The He3+n reaction only produces 0.764 Mev pulse. With respect to wall effects, the neutron detector 200 is thin so a very small fraction of the gamma energy is absorbed making very small gamma pulses. Pile up of pulses can produce a larger apparent pulse. However this is avoided with the fast electronics. The walls of the He3 detectors capture some energy, which broadens the pulse. Thus, such implementation typically uses large size tubes. With a broad neutron pulse fast electronics cannot be used to discriminate against gamma pulses during pile up without cutting out some of the neutron pulse energy.

With respect to pulse width, the neutron pulse width is narrower in the neutron detector 200 than in He3 detectors. This makes the use of fast electronics more beneficial. With respect to, thermal neutron efficiency He3 is very efficient 90% at 0.025 eV neutrons. However He3 efficiency drops off rapidly to 4% for 100 ev neutrons. Because He3 is a gas a large volume detector is needed to get this efficiency. He3 efficiency coupled with a moderator assembly is estimated at between 30% down to 1% across the energy range and depends on He3 volume. The neutron detector 200 is a solid material, and smaller volumes can be used. Multiple layers of the neutron detector 200 raise the overall detector system efficiency. In one embodiment of the present invention, a four layer configuration of the neutron detector 200 was constructed that reached efficiencies of close to 100%. The neutron detector 200 efficiency coupled with the moderator assembly is estimated at 30% across the energy range.

The neutron detector 200 is advantageous over conventional helium-3 neutron detectors for the following reasons. The neutron detector can be shaped into any desired form. The neutron detector comprises uniform efficiency across the detector area. Also, multiple layers of the detector can create an efficiency which is close to 100%.

Detection of Shielded HEU (Passively)

The neutron detector 200, in one embodiment, is an effective passive detector of specialized nuclear materials. The most difficult to detect is typically highly enriched uranium (HEU). More difficult is shielded highly enriched uranium. The HEU detection capabilities were analyzed and the conclusions are discussed below. The useful radioactive emissions for passively detecting shielded HEU are neutron and gamma rays at 1 MeV from decay of U-238. The neutrons offer the best detection option. The gamma rays with energy below 200 KeV are practical for detecting only unshielded HEU since these are too easily attenuated with shielding. The most effective detection solutions will place detectors with the largest possible area and most energy-specificity within five meters and for as long a time as possible since: (a.) at distances of 10 meters or more, the solid angle subtended by the detector (˜detector area/distance2) from a 50 kg HEU source is likely to reduce the signal as much as any reasonable size shielding, and (b) with sufficient time for the detector to detect neutron counts and photon counts within a narrow enough photon energy range, even signals below the background can be detected.

In one model applicable to one or more embodiments of the present invention, it is assumed that the HEU core is shielded externally by lead. The linear attenuation coefficient, defined as the probability per unit distance that a gamma ray is scattered by a material, is a function of both the material and the energy of the gamma ray. Steel and concrete have linear attenuation coefficients at 1 MeV that are not all that different from lead, so the conclusions will be roughly similar even with other typical shielding materials. In addition to the external shield, the mass of HEU itself acts to shield gamma rays (self-shielding). The number of neutrons and gamma rays that reach the detector is limited by the solid angle subtended by the detector from the source. Finally, detection involves reading enough counts of neutrons and gamma rays to be able to ascertain a significant deviation from the background and the detector only detects a fraction of those neutron and gamma rays that are emitted due to detection inefficiencies. Each of these factors when put together forms a “link budget” and is explained below.

Nuclear theory is used to estimate the maximum distance possible for passive detection of a lead-shielded HEU spherical core using both U-238 and U-232 signals. The distance compared against variables of interest including detector area, detection time, shield thickness, and mass of the HEU core. Detection distance depends on amount of HEU and its surface area, shielding, detector area, distance, and time available to detect the emissions. Maximum detection distance is dependent on these factors. The neutron emissions and the neutron detector 200 are used, in this example, to enable neutron detection to four counts above background noise levels. The low number neutron counts and the low number 1 MeV gamma counts are used to identify the source as a high probability of shielded HEU.

Neutron Emissions of U-238, U-235, and U-234

The neutron “link budget” is not easily amenable to analytical approximation as it is for gammas. For a comparison with gammas, the basics of neutron emissions and attenuation are presented here in the specific case of weapons grade Uranium (WgU). Weapons grade Uranium (WgU) emits neutrons at the rate of roughly 1/s/kg with an energy distribution centered around 1 MeV—primarily due to spontaneous fission of Uranium isotopes, with each of 234, 235, and 238 contributing roughly equal numbers of neutrons given their relative composition in WgU. These energetic neutrons also have mean free path lengths of 2-6 cm in most shielding materials (tungsten, lead, etc.) whereas 1 MeV gammas are only ˜1 cm by comparison. A 24 kg WgU sample with tungsten tamper emits 60 neutrons per second in addition to 60 1 MeV gamma rays per second at the surface of the sample. The path loss through free space is equivalent for both forms of radiation. Although neutrons may pass through shielding further than 1 MeV gammas, the difference is small enough that detection of shielded HEU using neutrons and the identification of shielded HEU through the combined detection of low counts for both neutrons and 1 MeV gamma is viable.

Gamma Emissions of U-238, U-235, And U-232

Uranium consists of multiple isotopes. By definition highly enriched Uranium (HEU) has more than 20% 13 of the isotope U-235 which is fissile, and weapons grade Uranium contains over 90% 14 U-235. Radioactive decay of U-235 results in gamma rays at 185 KeV, but shielding too easily attenuates these and so they are not useful for detecting shielded HEU. HEU also contains the isotope U-238—the more highly enriched, the less the percentage of U-238. A conservative assumption for detection using U-238 emissions is that HEU or weapons grade Uranium contains at least 5% U-238 by weight. U-232 may also be present in trace quantities (parts per trillion).

U-238 emits 81 gammas per second per gram at 1.001 MeV. This number can also be derived using first principles and nuclear data, but results in only a slightly higher value based on data from U-232's decay chain produces even more penetrating gamma rays than U-238. The most important gamma emitter in the U-232 decay chain is Tl-208, which emits a 2.6 MeV gamma ray when it decays. These gamma rays can be effectively used to detect the presence of HEU if U-232 is known to be a contaminant, even to the effect of a few hundred parts per trillion. Embodiments of the present invention can similarly arrive at the rates for U-232, the most penetrating of which has emissions at 2.614 MeV at a rate of 2.68×1011 gammas per gram per second.

In an analysis of the neutron detector system 100 it was determined that the ability to create a large neutron detector surface area with enhanced performance through modifications to the conventional preamp, use of digital electronics described in the sensor interface unit, advanced background subtraction methods and advanced spectral analysis methods, the system 100 was able to detect and identify special nuclear materials such as highly enriched uranium and shielded highly enriched uranium at quantities below 24 kilograms through a combination of neutron and gamma detections.

The passive scintillation detector system discussed above can be configured to detect and identify shielded highly enriched uranium based on low neutron counts coupled with low 1 MeV gamma counts. The system detects and identifies highly enriched uranium based on low level neutron counts coupled with low gamma counts at 1 MeV or greater energies coupled with gamma ray energy associated with HUE that are below 200 KeV.

The passive scintillation detector system discussed above can also be configured as a horizontal portal, a truck or bomb cart chassis, a spreader bar of a gantry crane, a straddle carrier, a rubber tired gantry crane, a rail mounted gantry crane, container movement equipment, a truck, a car, a boat, a helicopter, a plane or any other obvious position for the inspection and verification of persons, vehicles, or cargo. The system can be configured for military operations or military vehicles, and for personal detector systems. The system can also be configured for surveillance and detection in protection of metropolitan areas, buildings, military operations, critical infrastructure such as airports, train stations, subway systems or deployed on a mobile platform such as a boat, a vehicle, a plane, an unmanned vehicle or a remote control vehicle.

Information Processing System

FIG. 8 is a block diagram illustrating a more detailed view of an information processing system 800 according to one embodiment of the present invention. The information processing system 800 is based upon a suitably configured processing system adapted to be implemented in the neutron detection system 100 of FIG. 1. Any suitably configured processing system is similarly able to be used as the information processing system 800 by embodiments of the present invention such as an information processing system residing in the computing environment of FIG. 1, a personal computer, workstation, or the like.

The information processing system 800 includes a computer 802. The computer 802 has a processor(s) 804 that is connected to a main memory 806, mass storage interface 808, terminal interface 810, and network adapter hardware 812. A system bus 814 interconnects these system components. The mass storage interface 808 is used to connect mass storage devices, such as data storage device 816, to the information processing system 800. One specific type of data storage device is an optical drive such as a CD/DVD drive, which may be used to store data to and read data from a computer readable medium or storage product such as (but not limited to) a CD/DVD 818. Another type of data storage device is a data storage device configured to support, for example, NTFS type file system operations.

In one embodiment, the information processing system 800 utilizes conventional virtual addressing mechanisms to allow programs to behave as if they have access to a large, single storage entity, referred to herein as a computer system memory, instead of access to multiple, smaller storage entities such as the main memory 806 and data storage device 816. Note that the term “computer system memory” is used herein to generically refer to the entire virtual memory of the information processing system 800.

Although only one CPU 804 is illustrated for computer 802, computer systems with multiple CPUs can be used equally effectively. Embodiments of the present invention further incorporate interfaces that each includes separate, fully programmed microprocessors that are used to off-load processing from the CPU 804. Terminal interface 810 is used to directly connect one or more terminals 820 to computer 802 to provide a user interface to the computer 802. These terminals 820, which are able to be non-intelligent or fully programmable workstations, are used to allow system administrators and users to communicate with the information processing system 800. The terminal 820 is also able to consist of user interface and peripheral devices that are connected to computer 802 and controlled by terminal interface hardware included in the terminal I/F 810 that includes video adapters and interfaces for keyboards, pointing devices, and the like.

An operating system (not shown) included in the main memory is a suitable multitasking operating system such as the Linux, UNIX, Windows XP, and Windows Server 2003 operating system. Various embodiments of the present invention are able to use any other suitable operating system. Some embodiments of the present invention utilize architectures, such as an object oriented framework mechanism, that allows instructions of the components of operating system (not shown) to be executed on any processor located within the information processing system 800. The network adapter hardware 812 is used to provide an interface to a network 822. Embodiments of the present invention are able to be adapted to work with any data communications connections including present day analog and/or digital techniques or via a future networking mechanism.

Although the various embodiments of the present invention are described in the context of a fully functional computer system, those skilled in the art will appreciate that embodiments are capable of being distributed as a program product via CD or DVD, e.g. CD 818, CD ROM, or other form of recordable media, or via any type of electronic transmission mechanism.

Examples of Gamma and Neutron Detectors

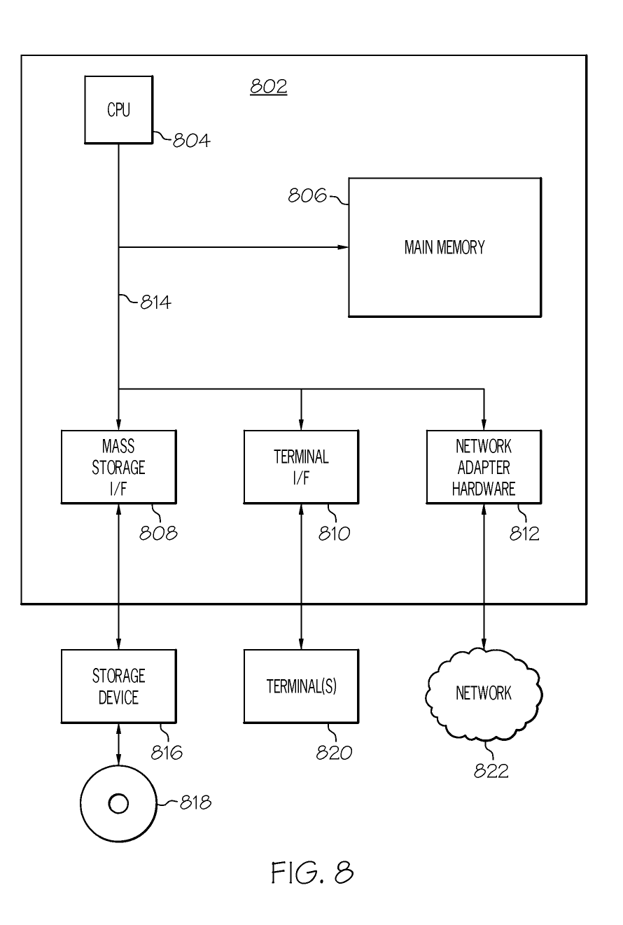

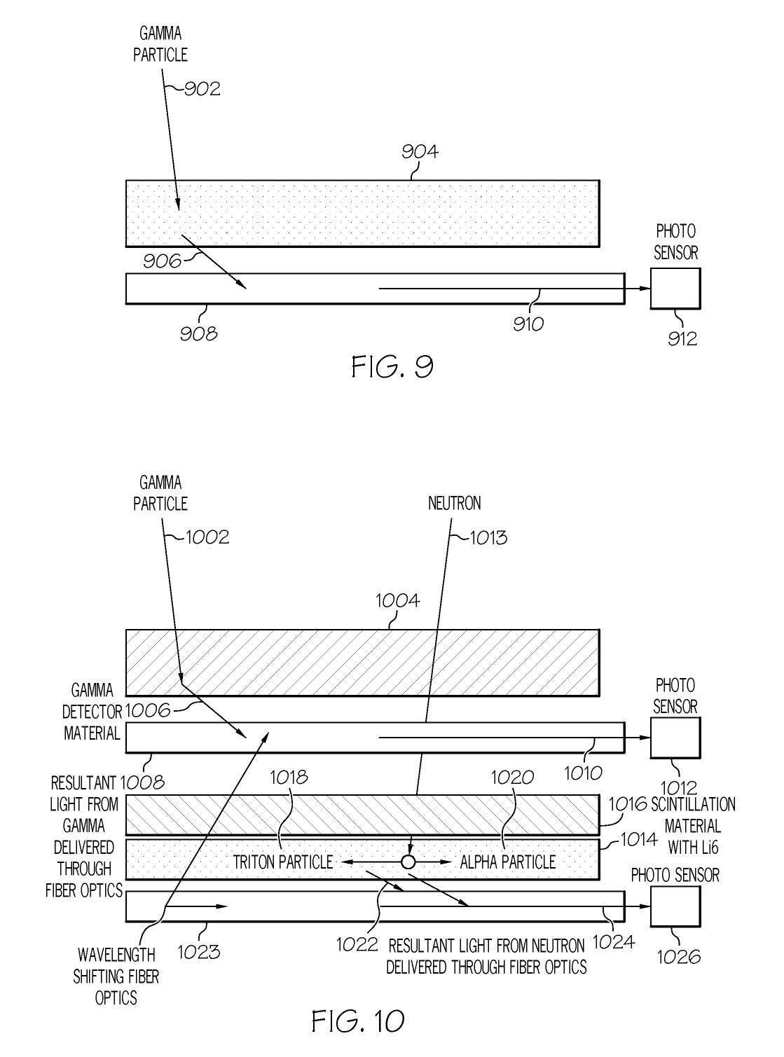

In FIG. 9, Polyvinyl Toluene material 904 (such as in a layer or other structural configuration) is excited by an incident gamma particle 902 and energized by this interaction and releases the energy as photons (light) 906. The photons (light) 906 travel into optical fibers 908 and are guided as light 910 to the ends of the fibers 908 and thereby exit into the photosensor 912.

In FIG. 10, Polyvinyl Toluene material 1004 is excited by an incident gamma particle 1002 and energized by this interaction and releases the energy as photons (light) 1006. The photons (light) 1010 travel into the fibers 1008 (which in this example are wavelength shifting fiber optics) and are guided as light 1010 to the ends of the fibers 1008 and thereby exit into the photosensor 1012. Gammas detected by the aforementioned structure are blocked from entering a neutron detector element below the gamma detector. The scintillation material (e.g., including 6Li material) 1014 is excited by an incident neutron 1013 that is slowed by a moderator material 1016 and reacts in the scintillation material 1014 by emitting an alpha particle 1020 and a triton particle 1018 into the neighboring phosphor material in the scintillation material 1014. The phosphor material 1014 is energized by this interaction and releases the energy as photons (light) 1022. The photons (as light) travel into the fibers 1023 (which in this example are wavelength shifting fiber optics) and are guided as light 1024 to the ends of the fibers 1023 and exit into the photosensor 1026.

Gamma particles that pass through the Polyvinyl Toluene material 1004 and hit the phosphor material 1014 can also create photons (light) that pass into the fibers 1023 and are guided as light 1024 to the ends of the fibers 1023 and exit into the photosensor 108.

Neutron Detector with Progressive Moderators

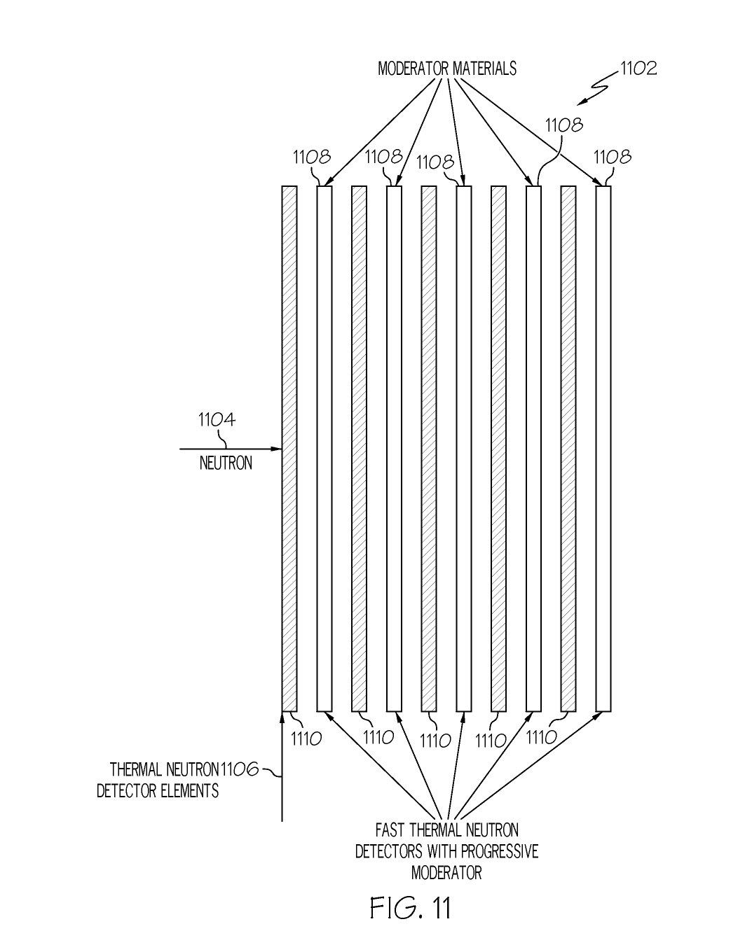

In FIG. 11 the moderator materials (601) are layered between thermal neutron detector elements (602) to create progressively moderated neutrons. The first detector element (602) has no moderator material in front of it to enable detection of thermal neutrons.

Neutron Detector with a Photosensor Reference

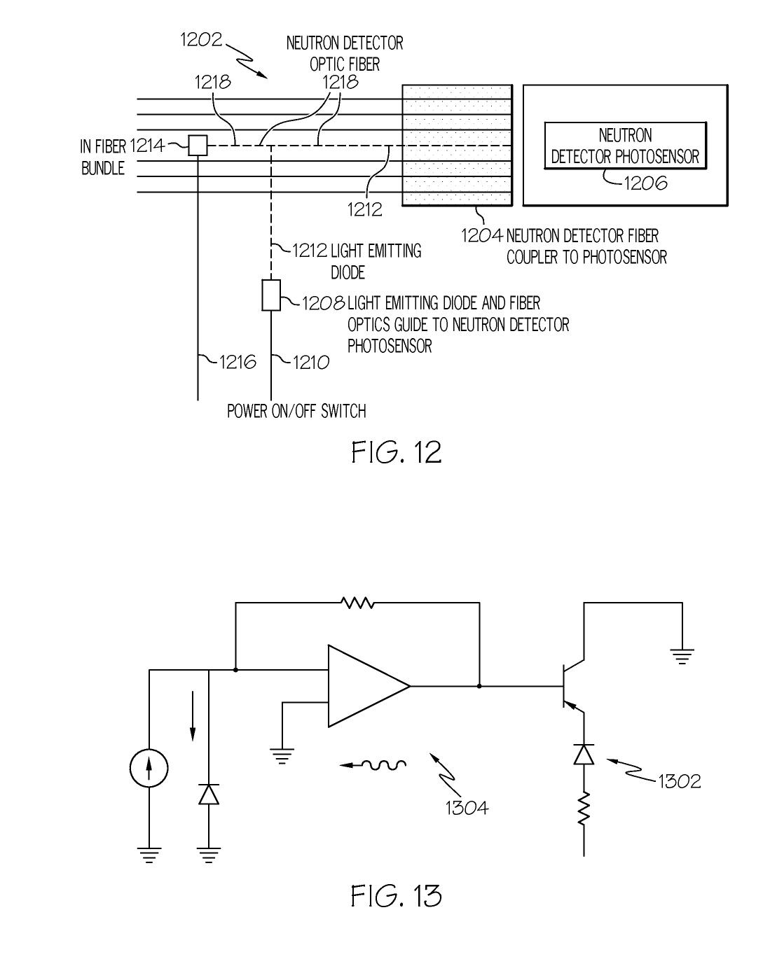

In FIG. 12, a temperature compensated light emitting diode (LED) (701) is attached to a fiber media that is coupled (705) at the photosensor to provide a pulse similar to a neutron pulse into the photosensor (704). LED 708 is an alternative where the light from the LED is fed into the wavelength-shifting fibers of the neutron detector to present a pulse to the photosensor. Both methods, LED (701) and LED (708) provide a reference signal to calibrate for issues such as photo-multiple drift in the event a photo-multiplier tube is used as a photosensor and changes in the photosensor output due to temperature. The LED (701 or 708) is controlled by the neutron detector system providing an on/off (702) indication for the LED to begin pulsing and to stop pulsing.

One of the issues associated with calibration of the neutron detector is the photosensor gain and the calibration of the gain to obtain an optimum configuration for pulse shape differentiation between gamma and neutron pulses.

As temperature linearly increases or decreases, the light intensity of an LED exponentially decreases or increases respectively. The circuit configuration shown in FIG. 8 is an example of how to minimize the intensity dependency on temperature problems in a voltage sourced application where the LED current is set with the LED in series with a current limiting resistor.

The example of a temperature compensation circuit shown in FIG. 13 utilizes a temperature compensated current source feeding a PIN photo-diode and a trans-resistance amplifier. The trans-resistance amplifier's output drives the base of a PNP transistor used to supply voltage and current to the LED and current limiting resistor.

Neutron Detectors with Various Arrangements of Photosensor Connections

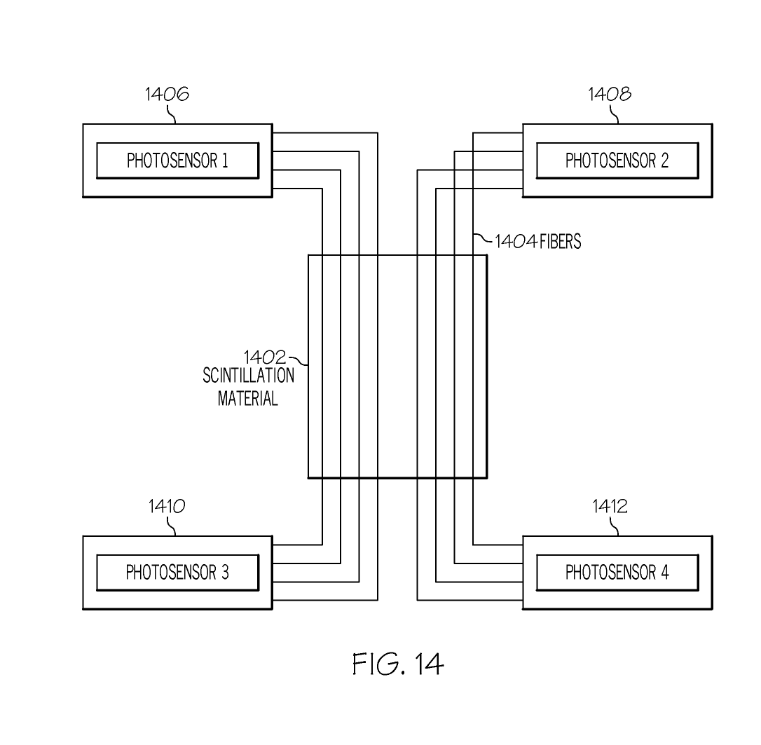

In FIGS. 14, 15, 16, and 17 fibers are respectively distributed through scintillation material to multiple photosensors. The various example arrangements of fibers coupled with photosensors enable gamma and neutron detectors to effectively handle a higher number of gamma and neutron events through a division of these events across multiple photosensors and different supporting sensor electronics connected to each of the photosensors. The fibers can be segregated such as a left side group and a right side group or can be integrated across a detector.

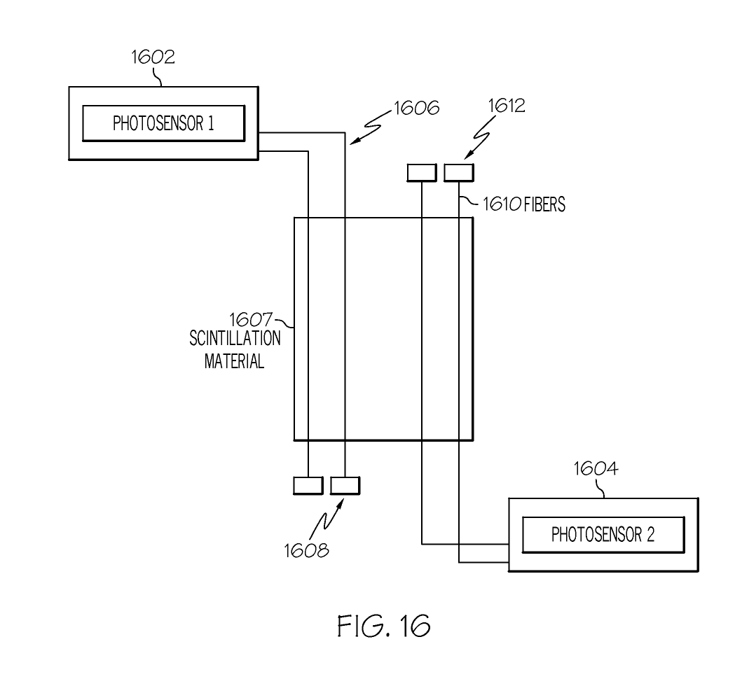

In FIGS. 14 and 16 the fibers are segmented to form a left side and right side detector group within an overall detector.

In FIG. 14, the fibers 1404 are interleaved and connected through scintillation material 1402 to multiple photosensors 1406, 1408, 1410, and 1412, arranged in two groups.

In FIG. 16, the fibers 1606, 1619, are connected to a respective photosensor 1602, 1604, on one side only and terminated 1608, 1612, on the other side of the detector. The fibers 1606, 1619 may be terminated 1608, 1612 using any of non-reflective material, light absorbing material, or reflective material, at the terminator 1608, 1612. By using terminators 1608, 1612, the cost of implementing a gamma and neutron detector can be reduced thereby enhancing the commercial viability of a detector system.

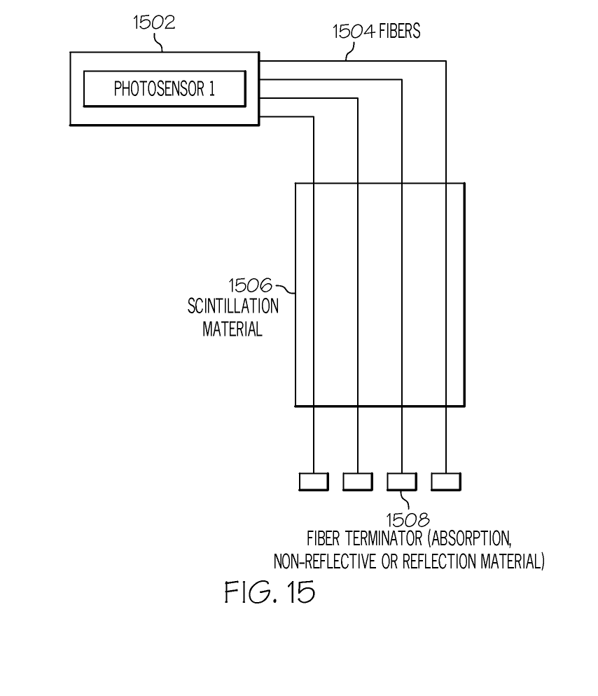

In FIG. 15, the fibers 1504 are connected to a photosensor 1502 on one side only and the fibers are connected through scintillation material 1506 to terminators 1508 thereby being terminated on the other side of the detector. The fibers 1508 may be terminated using any of non-reflective material, light absorbing material, or reflective material, at the terminator 1508. By connecting the fibers 1506 on one side to one photosensor 1502 and on the other side to terminators 1508, the cost of implementing a gamma and neutron detector can be even further reduced over the example shown in FIG. 16, thereby further enhancing the commercial viability of a detector system.

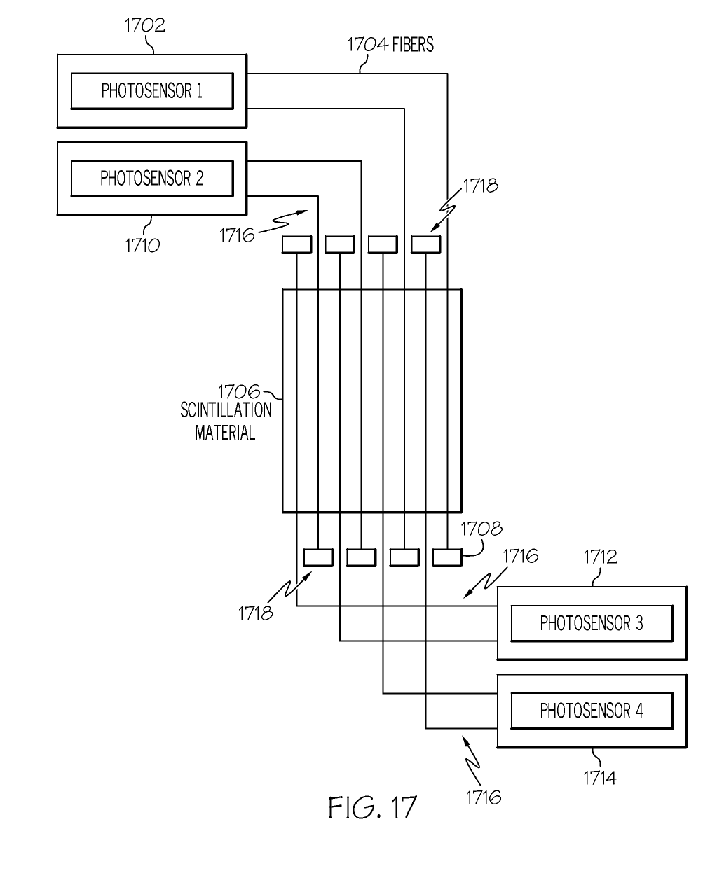

In FIG. 17, the fibers 1704, 1716, are shown interleaved and connected through scintillation material 1706 on one side to respective photosensors 1702, 1710, 1712, 1714, and on the other side of the fibers 1704, 1716, connected to respective terminators 1708, 1718. The fibers 1704, 1716 may be terminated using any of non-reflective material, light absorbing material, or reflective material, at the respective terminators 1708, 1718. This arrangement integrates the fibers 1704, 1716, though the scintillation material 1706 and individually connects each fiber 1704, 1716, to only one respective photosensor 1702, 1710, 1712, 1714. As can be seen by the various examples shown in the FIGS. 14 to 17, many different arrangements of fibers connected with photosensors, optionally including terminators on one side of one or more of the fibers, are anticipated by various embodiments of the present invention.

Neutron Detector and Moderator in a Spatial Distribution Arrangement

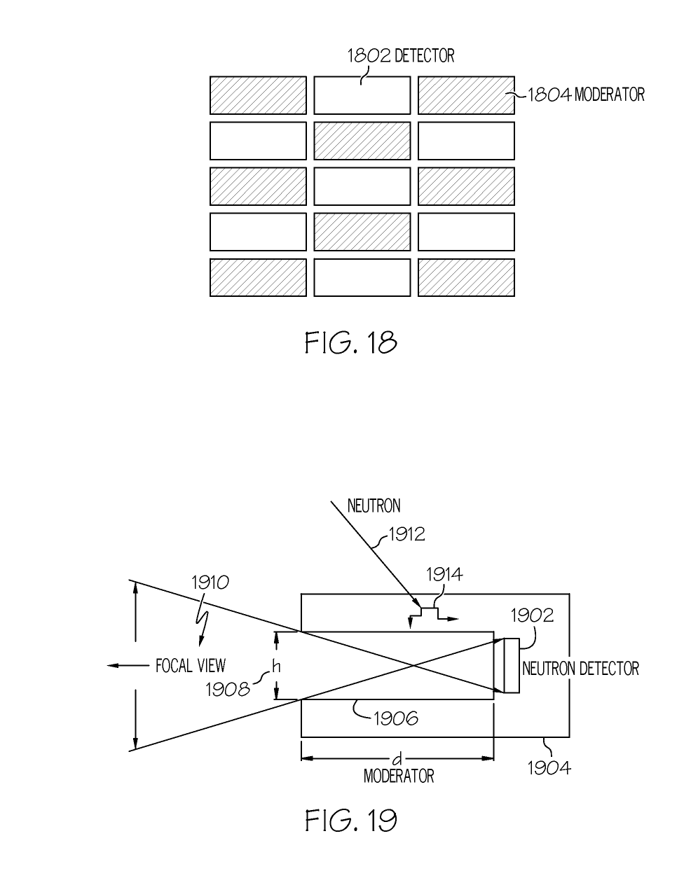

In FIG. 18, detector elements (or alternatively detectors) 1802 are combined with hydrogenous materials (moderators) 1804 in a spatially distributed configuration to increase overall thermal neutron sensitivity. By spatially distributing the detector elements (or the detectors) 1802 with the moderators 1804 as shown, more neutrons would be detected. The hydrogenous materials may be exchanged with non-hydrogenous materials to enable spatial distribution. Each detector, in an overall structure such as shown in FIG. 18, may include further spatial distribution in the detector by detector elements and moderator that, in one embodiment, would appear at the detector level as spatially distributed elements such as shown in FIG. 18. This spatial distribution approach, of detectors and of detector elements within at least one detector, will maximize the likelihood of neutron particles being detected by at least one detector or detector element. It should be understood that, according to one embodiment, a detector element comprises scintillation material optionally configured as one or more layers of scintillation material. The detector element would be spatially separated from another detector element by moderator material in an overall detector.

Focal Neutron Detector

In FIG. 19, a neutron detector 1902 is surrounded by a neutron absorbing material 1904 to eliminate 1914 background neutrons 1912. The opening, of a given height (or diameter for a circular opening) 1908 and depth 1906, in the front region of the neutron absorbing material 1904 allows the neutron detector 1902 to receive neutrons coming from a specific direction defined by a focal view 1910. Standard moderator material may be used in the active moderator region at the front face of the neutron detector 1902. Boron poly shielding material for neutron restriction can be used as the neutron absorbing material 1904 surrounding the neutron detector 1902 from all other directions except from the focal view 1910. The focal view 1910 is based on the height and width (or diameter for a circular opening) 1908 and the depth 1906 of the tunnel opening to the neutron detector 1902, which otherwise is surrounded by the neutron absorbing material 1904. Sensitivity of the neutron detector 1902 is increased by reducing background noise and interference from all directions other than the direction defined by the focal view 1910.

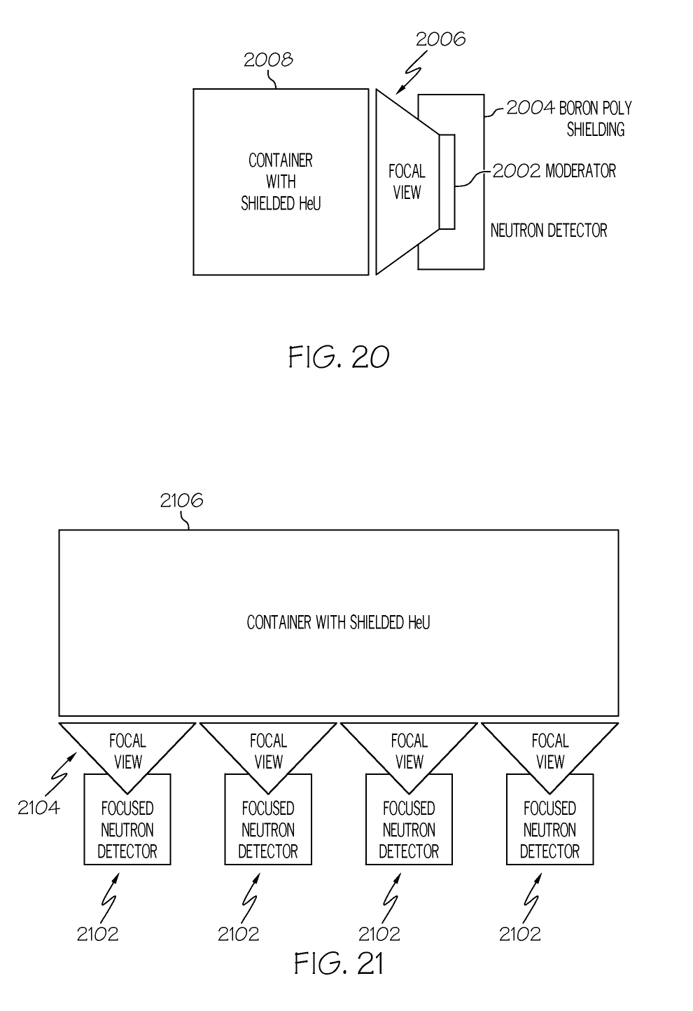

FIGS. 20 and 21 illustrate one or more focal neutron detectors deployed for inspection of shipping containers. In FIG. 20, a neutron detector 2002 is surrounded by moderator 2004, such as a moderator including Boron Poly shielding material for neutron restriction, except where the focal view 2006 (tunnel opening) permits traveling neutrons to be received by the neutron detector 2002. Standard moderator material may be used in the active moderator region at the front face of the neutron detector 2002. Neutron background is substantially eliminated from above, below, and behind the neutron detector 2002. There is essentially no neutron background from outside of the focal view 2006. A container 2008 is shown in a field of view defined by the focal view 2006. The neutron detector 2002 can inspect the contents of the container 2008 by detecting neutron emissions from radioactive materials (such as highly enriched Uranium) that could be shielded inside the container 2008.

FIG. 21 illustrates a one sided horizontal array 2104 of focal neutron detectors 2102 used to inspect a container 2106 in the respective focal views 2104 of the neutron detectors 2102 in the array 2104. The neutron detector array 2104 can inspect the contents of the container 2106 by detecting neutron emissions from radioactive materials (such as highly enriched Uranium) that could be shielded inside the container 2106. The use of a horizontal array 2104 enables a fixed geometry for the detector array 2104 and an extended time for detection of neutron emissions from the container 2106. It is clear in view of the discussion above that the horizontal array could also be deployed as a two-sided array or a multisided array. Alternatively, a vertical detector array (not shown) rather than a horizontal array could be implemented using similar neutron detectors 2102 arranged in a vertical array. Various arrangements of one or more neutron detectors 2102 can be implemented in many different applications, which may include applications to detect neutron emissions from radioactive materials that are shielded inside containers 2106.

Example of a Neutron Detector

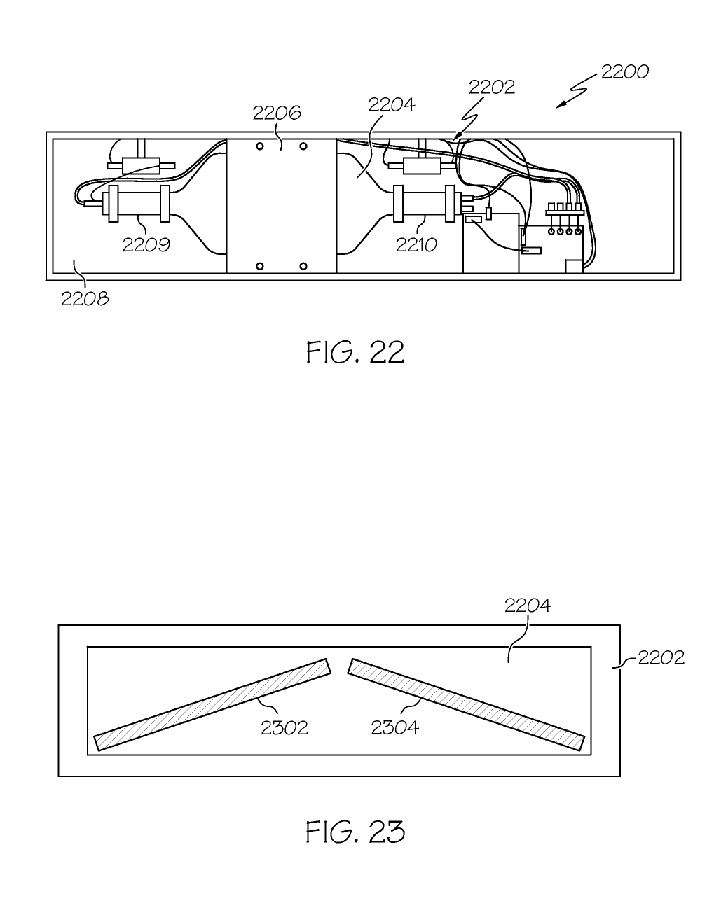

FIGS. 22 and 23 show one example of a neutron detector 2200 with a side of a detector box removed to show the detector components inside. In this example, the detector 2200 is enclosed in a detector box with two detector components 2302, 2304, (also shown in FIG. 22 as a combined detector structure 2204), with one detector component 2306 going one way, and the other detector component 2308 going the other way in a V-shape, as shown in FIG. 23. Each detector component 2302, 2304, in this example, is optically coupled with a respective photomultiplier tube 2209, 2210. Each detector component, while not shown in FIGS. 22 and 23, includes one or more layers of detector element and optionally one or more layers of moderator all combined into a sandwich structure. Additionally, a box of moderator material 2202 encloses the two detector components 2302, 2304, and is located inside the outer detector box. This moderator box 2202 includes moderator material on all sides 2206, 2208, 2202, surrounding the detector assembly 2204 comprising the two detector components 2302, 2304. This moderator box configuration (surrounding the one or more detector components) enhances the detection of incident neutrons by the one or more detector components in the moderator box 2202. Also shown in FIG. 22 are the detector electronics and other supporting components of the detector 2200. There is something remarkable about having a moderator box 2202 around the detector. What happens is that the moderator box 2202 appears to give a larger face to the detection area. A neutron typically has to be moderated before it can be detected by a thermal neutron detector, and when it goes through that moderator material in the moderator box 2202, the neutron will bounce around in all directions inside the moderator box 2202. This increases the likelihood that the neutron will impact the scintillation material in the one or more detector components 2302, 2304.

While a detector element may be relatively small, like in a helium 3 device, which normally can have a small helium 3 tube and the tube is only 2 inches, the moderator box 2202 may be 10 inches on a side. So the detector has a 10 inch collection face feeding neutrons into the smaller detector inside the moderator box 2202. The outside moderator box 2202 provides a larger initial front face to the world for collection of incident neutrons that could be absorbed by the one or more neutron detector components 2302, 2304, as the neutron is reflected inside the cavity of the moderator box 2202. This moderator box 2202 is particularly useful for slowing down (thermalizing) fast neutrons. However, even thermal neutrons could be further thermalized by the moderator box 2202 for better detection by the one or more neutron detector components 2302, 2304.

FIG. 23 illustrates the detectors 2302, 2304, configured in angles within the moderator box 2202 to create an optimum efficiency. Here the moderator box 2202 encloses the full detector assembly 2204. The detector elements 2302, 2304, are placed at angles to form a V shape arrangement within the cavity of the moderator box 2202. The angled detectors 2302, 2304, within the moderator box 2202 allows for greater interaction with the neutrons.

Alternative Configurations of Detectors

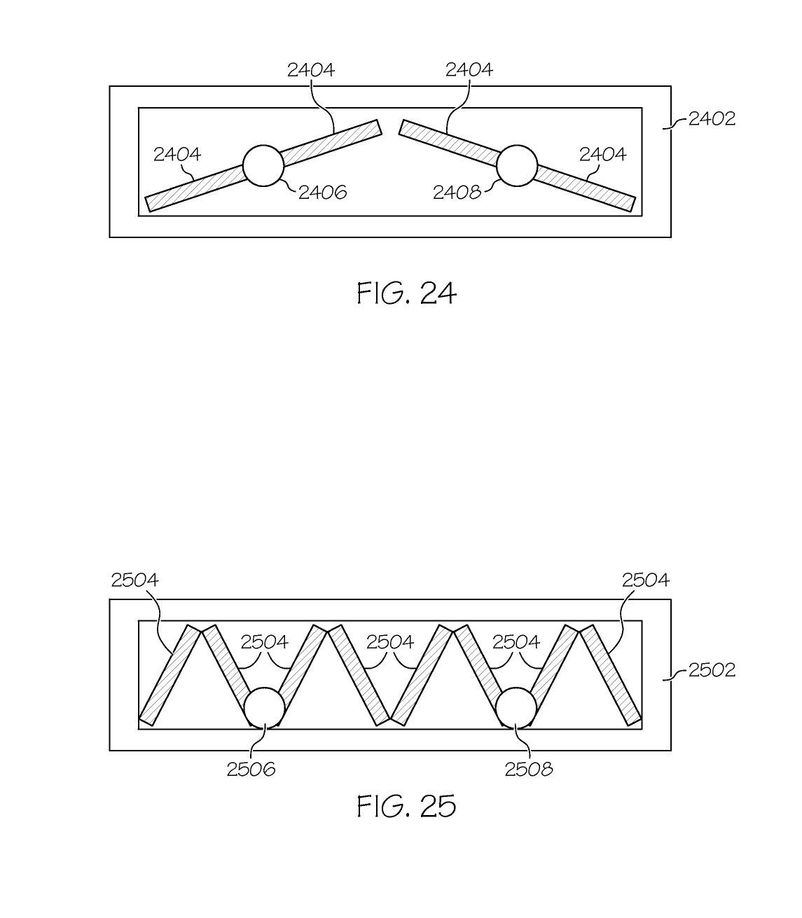

FIGS. 23, 24, and 25, provide a gain in peripheral detection of neutron collisions. These three figures show detectors in a moderator box from a top down view inside the moderator box. FIGS. 24 and 25 also show photosensors optically coupled with the detectors inside the moderator box. For example, FIG. 24 provides a plurality of detectors 2404 arranged generally in a V-shape inside the moderator housing 2402, similar to that shown in FIG. 23. However, two detectors of the plurality of detectors 2404 are optically coupled with respective each of two photosensors 2406, 2408. This arrangement, and additionally combined with other detector element configurations discussed herein, helps increase the gain in detection of neutron collisions for the detectors 2404 inside the moderator box 2402. FIG. 25 shows a corrugated arrangement of a plurality of detectors 2504, with four detectors optically coupled with respective each of two photosensors 2506, 2508. This corrugated arrangement, and additionally combined with other detector element configurations discussed herein, helps further increase the gain in detection of neutron collisions for the detectors 2504 inside the moderator box 2502.

Additionally, the scintillation material in a detector or detector element, according to various embodiments, may comprise at least one of Li3PO4 and Li6ZnSAg. A phosphor material in the scintillation material converts collisions of incident neutron particles, that generate triton particles or gamma particles, to light photons. It should be noted that various embodiments that have been discussed above with reference to all of the present figures, may comprise at least one of Li3PO4 and Li6ZnSAg material, and may also include clear binder material in the scintillation material of the particular embodiment. The clear binder material allows more light photons that are emitted out of the scintillation material to transmit through the clear binder material and be detected by a photosensor.

Optionally, a solid-state photomultiplier may be optically coupled with the scintillation material of a detector to directly detect the light photons emitted from the scintillation material without need for optical light guide fibers to be included with a detector. This configuration of a detector using a solid state photomultiplier reduces overall manufacturing costs, simplifies a manufacturing process, and is more compatible with a mass manufacturing operation, which enhances the commercial viability of this type of detector.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A scintillator detector comprising:
at least one scintillator layer comprising 6LiF and one or more phosphor materials mixed in a binder medium;
at least one photosensor having an optical input and an electrical signal output;
at least one light guide medium, optically coupled to the at least one scintillator layer and to the optical input of the at least one photosensor, for coupling one or more light pulses emitted from neutron particles interacting with scintillator material of the at least one scintillator layer into the at least one light guide medium and thereby guiding one or more light pulses to the optical input of the at least one photosensor that in response generates one or more electrical pulses in an electrical sensor signal;
a pre-amp circuit having an amplifier signal input that is electrically coupled to the electrical signal output of the at least one photosensor, and an output, the pre-amp circuit being configured to provide at its output an electrical amplifier signal having an optimum electrical signal pulse shape closely tracking the pulse duration and shape of each of one or more electrical pulses of the electrical sensor signal corresponding to respective one or more light pulses emitted from the scintillation material; and
an analog to digital converter having an input electrically coupled to the output of the pre-amp circuit, and an output for providing a digital sensor signal corresponding to the electrical amplifier signal; and
digital signal processing circuits, having an input electrically coupled to the output of the analog to digital converter, for performing pulse shape differentiation on the digital sensor signal based on one or more neutron signal shape filters and one or more gamma signal shape filters that are applied to the digital sensor signal to reduce, eliminate, or separate gamma pulse signal detection from neutron pulse signal detection by the scintillator neutron detector.

2. The scintillator detector of claim 1, wherein a moderator material is disposed externally surrounding the at least one scintillator layer, and without moderator material being interposed between any two of the at least one scintillator layer of the scintillator detector.

3. The scintillator detector of claim 1, wherein the one or more phosphor materials comprise ZnS(Ag).

4. The scintillator detector of claim 1, wherein the at least one light guide medium, at the at least one scintillator layer, being substantially surrounded by plastic that acts as a wavelength shifter and couples light photons into the at least one light guide medium.

5. The scintillator detector of claim 1, further comprising at least one plastic layer adjacent to the at least one light guide medium at the at least one scintillator layer, the at least one plastic layer acting as a wavelength shifter and coupling light photons into the at least one light guide medium.

6. The scintillator detector of claim 1, wherein the 6LiF and one or more phosphor materials are mixed in the binder medium and with the scintillator layer together having a thickness of about 0.1 mm to about 0.25 mm.

7. The scintillator detector of claim 1, wherein the at least one scintillator layer comprises scintillator material mixed in a binder material that includes one or more of ZnS, ZnS(Ag), and NaI(Tl).

8. The scintillator detector of claim 1, wherein the at least one light guide medium comprises fiber optic media.

9. The scintillator detector of claim 1, wherein the photosensor comprises a photomultiplier tube, and wherein the at least one light guide medium comprises at least one wavelength shifting fiber that optimizes at least one optical signal delivered by the at least one wavelength shifting fiber from the at least one scintillator layer to the photomultiplier tube.

10. The scintillator detector of claim 1, wherein the photosensor comprises a photomultiplier tube that is tuned to operate close to the light frequency of the light photons generated from the scintillator material of the at least one scintillator layer and delivered by the at least one light guide medium to the photomultiplier tube.

11. The scintillator detector of claim 1, wherein the at least one scintillator layer and moderator material are curved and configured for up to a 360 degree effective detection angle of incidence.

12. The scintillator detector of claim 1, wherein the at least one scintillator layer and moderator material are flat and designed as a detector panel.

13. The scintillator detector of claim 1, wherein the moderator material is configured to enable fast neutrons and thermal neutrons to be detected by interaction with the scintillator material of the at least one scintillator layer.

14. The scintillator detector of claim 1, further comprising a light protective covering applied to the scintillator detector and eliminating external light intrusion into the scintillator detector.

15. The scintillator detector of claim 1, further comprising a temperature sensor thermally coupled with at least one of the scintillation material and the photosensor of the detector, wherein the temperature sensor monitors operating temperature of components of the scintillator detector for at least one of automated and manual calibration of scintillator detector output signals.

16. The scintillator detector of claim 1, wherein the at least one light guide medium comprises a plurality of staggered layers of parallel optical fiber strands sandwiching scintillator material between the plurality of staggered layers of parallel optical fiber strands, and wherein the parallel optical fiber strands of two layers sandwiching scintillator material therebetween comprise a substantially uniform diameter and are staggered relative to each other by less than or equal to the substantially uniform diameter thereof.

17. The scintillator detector of claim 1, further comprising a temperature compensated light emitting diode optically coupled to fiber media that is optically coupled to the at least one scintillator layer and to the photosensor to provide a reference signal as a pulse similar to a neutron pulse into the photosensor.

18. The scintillator detector of claim 1, wherein one or more of the following programmable filters are used to eliminate noise and most gamma pulses:
(a) a LLD (low level discriminator) or noise canceller as well as employing a pulse rise time filter;
(b) pulses must meet a minimum rise time to be considered for analysis; and
(c) a next stage of signal processing occurs at a pulse width filter, which measures the duration of the pulse at a point where the shape widens when the pulse originates from a neutron reaction, wherein gamma pulses are characterized as having a clean and rapid decay, while neutron pulses resulting from neutron interaction with the detector are characterized as having an extended fall time.

19. The scintillator detector of claim 1, wherein the analog to digital converter comprises a high speed analog-to-digital conversion circuit configured to sample a fastest pulse of the one or more electrical pulses in the electrical sensor signal with 15 or more points of high resolution data.

20. The scintillator detector of claim 1, wherein moderator surrounds an entire detector assembly of the scintillator detector.

21. The detector system of claim 1, wherein one end of the detector is configured with a reflective, non-reflective or light absorption material for termination of the optical fiber media.

22. A scintillator detector system comprising:
an information processing system; and
at least one neutron and/or gamma detector, coupled with the information processing system, the at least one detector comprising:
a plurality of scintillator layers comprising 6LiF and one or more phosphor materials mixed in a binder medium;
a photosensor electrically coupled to a sensor circuit;
at least one light guide medium optically coupled to the plurality of scintillator layers and to the photosensor for coupling light photons emitted from neutron particles interacting with scintillator material in the plurality of scintillator layers into the at least one light guide medium and thereby to the photosensor;
a sensor circuit having an electrical signal input electrically coupled to an electrical signal output from the photosensor; and
a moderator material disposed externally surrounding the plurality of scintillator layers, and without moderator material being interposed between any two of the plurality of scintillator layers of the at least one neutron and/or gamma detector.

23. A gamma and/or neutron detector system, comprising one or more of any of the following:
a. one or more neutron detectors based on 6LiF mixed in a binder medium with first scintillator material, that are optically coupled to one or more first wavelength shifting fiber optic light guide media, and have a tapered portion of the one or more first wavelength shifting fiber optic light guide media extending from at least one end of the first scintillator material to guide light from the first scintillator material to a first photosensor at the tapered portion, and wherein an electrical output of the first photosensor is connected to an input of a first pre-amp circuit designed to operate close to a pulse rise time, pulse duration, and pulse decay time, of light pulses generated by the first scintillator material, without adding distortion; and
b. one or more gamma detectors based on second scintillator material, that are optically coupled to one or more second wavelength shifting fiber optic light guide media, and have a tapered portion of the second wavelength shifting fiber optic light guide media extending from at least one end of the second scintillator material to guide light from the second scintillator material to a second photosensor at the tapered portion, and wherein an electrical output of the second photosensor is connected to an input of a second preamp circuit designed to operate close to a pulse rise time, pulse duration, and pulse decay time, of light pulses generated by the second scintillator material, without adding distortion.

24. The detector system of claim 23, wherein at least one of the first photosensor and the second photosensor comprises any of a photomultiplier tube and an avalanche diode.

25. The detector system of claim 23, wherein the first scintillator material mixed with the binder medium comprises one or more materials of the following: ZnS, ZnS(Ag), and NaI(Tl).

26. The detector system of claim 23, wherein the binder medium comprises a hydrogenous binder.

27. The detector system of claim 23, wherein the binder medium comprises a non-hydrogenous binder.

28. The detector system of claim 23, wherein an output of the first pre-amp circuit is connected to first supporting electronics and an output of the second pre-amp circuit is connected to second supporting electronics, each of the first supporting electronics and the second supporting electronics providing a signal sampling rate of at least 50 million samples per second designed to operate close to the rise time and decay time of light pulses generated by the respective first scintillator material and second scintillator material.

29. The detector system of claim 23, wherein at least one of the one or more first wavelength shifting fiber optic light guide media and the one or more second wavelength shifting fiber optic light guide media, has two portions extending from the respective first scintillator material and the second scintillator material, and wherein first and second photosensors are optically coupled respectively to each of the two portions.

30. The detector system of claim 23, wherein at least one of the one or more first wavelength shifting fiber optic light guide media and the one or more second wavelength shifting fiber optic light guide media has two portions extending from the respective first scintillator material and the second scintillator material, and wherein a single photosensor is optically coupled to one of the two portions and the other of the two portions is terminated at an end opposing the single photosensor using any of light non-reflective material, light absorptive material, and light reflective material.

31. The detector system of claim 23, wherein at least one of the one or more first wavelength shifting fiber optic light guide media and the one or more second wavelength shifting fiber optic light guide media has a plurality of photosensors optically coupled to the respective tapered portion.

32. The detector system of claim 23, further comprising moderator material placed in between layers of the first scintillator material, the moderator material for moderating traveling neutrons within the one or more neutron detectors.

33. The detector system of claim 23, further comprising moderator material placed in between a plurality of layers of the first scintillator material and with a first outer layer of the first scintillator material remaining uncovered by moderator material, thereby enabling a thermal neutron detector and a fast neutron detector of progressively moderated neutrons.

34. The detector system of claim 33, wherein the plurality of layers of the first scintillator material comprise multiple thermal neutron detector layers that detect progressively moderated neutrons and provide a differential neutron energy detection capability that represents detection of a signature of a fissile material type.

35. The detector system of claim 23, wherein at least one of the one or more first wavelength shifting fiber optic light guide media and the one or more second wavelength shifting fiber optic light guide media has a plurality of photosensors optically coupled to the respective tapered portion, and wherein respective wavelength shifting fiber optic light guide media are segregated into a plurality of groups that are each connected to a separate photosensor in the plurality of photosensors.

36. The detector system of claim 23, further comprising one or more gamma pulse shape filters applied to the one or more neutron detectors to reduce or eliminate gamma cross talk from being reported by the respective one or more neutron detectors.

37. The detector system of claim 23, wherein the first scintillator material comprises a plurality of scintillation layers that are spatially distributed between moderator material that comprises hydrogenous material.

38. The detector system of claim 23, wherein the one or more neutron detectors comprise a plurality of neutron detectors that are spatially distributed between moderator material that comprises hydrogenous material.

39. The detector system of claim 23, wherein at least one of the one or more neutron detectors is surrounded by neutron absorbing material, except at a tunnel opening inside the neutron absorbing material defining a focal view in front of the at least one of the one or more neutron detectors, the neutron absorbing material limiting traveling neutrons from making contact with the at least one neutron detector except for traveling neutrons that are coming from a specific direction defined by the focal view in front of the at least one neutron detector.

40. The detector system of claim 39, wherein the at least one of the one or more neutron detectors has a near zero exposure to background neutrons coming from all directions other than the focal view in front of the at least one neutron detector.

41. The detector system of claim 39, wherein the at least one of the one or more neutron detectors comprises a plurality of neutron detectors, each having a focal view, and that are placed and oriented in at least one of: a one sided array, a multisided array, a horizontal array, and a vertical array, and that collectively can inspect for the presence of any of a fissile material, a shielded fissile material, highly enriched uranium, and shielded highly enriched uranium.

42. The detector system of claim 39, wherein the at least one of the one or more neutron detectors is deployed in a gamma and/or neutron detector system for the inspection of shipping containers.

43. The detector system of claim 39, wherein the at least one of the one or more neutron detectors is deployed on at least one of: cargo movement equipment, a gantry crane, a spreader bar, a straddle carrier, and a fixed portal.

44. The detector system of claim 23, further comprising a plurality of detector components oriented relative to each other in any of a V-shape configuration and a corrugated configuration.
